(19) United States
(12) Patent Application Publication
(10) Pub. No.: US 2024/0111654 A1
(43) Pub. Date: Apr. 4, 2024

(54) HYBRID PERFORMANCE MONITORING UNIT (PMU) ENUMERATION

(71) Applicant: Intel Corporation, Santa Clara, CA (US)

(72) Inventors: Raoul Rivas Toledano, Hillsboro, OR (US); Udayan Kapaley, Hillsboro, OR (US); Ahmad Yasin, Haifa (IL); Karthik Gopalakrishnan, Folsom, CA (US); Marc Torrant, Folsom, CA (US)

(21) Appl. No.: 18/374,296

(22) Filed: Sep. 28, 2023

Related U.S. Application Data
(60) Provisional application No. 63/411,521, filed on Sep. 29, 2022.

(51) Int. Cl. G06F 11/34; G06F 9/30

(52) U.S. Cl. CPC G06F 11/3466; G06F 9/30145; G06F 11/3409

(57) ABSTRACT

Detailed herein are examples of hybrid (heterogenous) performance monitoring unit enumeration. In some examples, a processor supports an instruction that enumerates performance monitoring unit enumeration. For example, the processor comprises decoder circuitry to decode an instance of a single instruction, the single instruction to include a field for an opcode; and execution circuitry to execute the decoded instruction according to the opcode to return the processor identification and feature information including an enumeration of heterogenous performance monitoring unit capabilities.

### BACKGROUND

Performance monitoring (e.g., using technologies such as Precise Event Based Sampling (PEBS) from Intel Corporation) of a processor can be used for characterizing, debugging, and tuning software and program code. However, the profiling data volumes may be huge. High performance processors go to great lengths to keep their execution pipelines busy, applying techniques such as large-window out-of-order execution, predictive speculation, and hardware prefetching. These techniques complicate the software tuning task and lead to varying cost for commonly monitored events.

### BRIEF DESCRIPTION OF DRAWINGS

Various examples in accordance with the present disclosure will be described with reference to the drawings, in which:

FIG. 1 is a block diagram illustrating a processor to generate and store PEBS and NPEBS records according to embodiments.

FIG. 2 illustrates an embodiment of a process to generate and store PEBS records in a memory buffer, and to store the memory buffer to a PEBS trace file.

FIG. 3 illustrates an embodiment of a process of programming a PEBS handler circuitto monitor processor performance and generate a PEBS record to be stored in a PEBS memory buffer, and then stored in a PEBS trace file.

FIG. 4 illustrates an embodiment of a method using a hardware and firmware to add performance cost to sampling (e.g., PEBS) records.

FIG. 5 illustrates examples of CPUID instruction execution.

FIG. 6 illustrates an example method performed by a processor to process a processor identification and feature information (CPUID) instruction.

FIG. 7 illustrates an example system configuration with three cores, where Core 1 and Core 3 have 4 counters each and Core 2 has only 2.

FIG. 8 illustrates an example system configuration with three cores, where Core 1 and Core 3 have 4 counters each and Core 2 has only 2.

FIG. 9 illustrates an example system with shows three OSes running simultaneously on a system with hypervisor (i.e., virtualization enabled). OS 1 runs with max privilege (i.e., fully trusted), OS 2 with medium privilege, and OS 3 with least privilege (i.e., untrusted).

FIG. 10 illustrates examples of computing hardware to process a CPUID instruction.

FIG. 11 illustrates an example computing system.

FIG. 12 illustrates a block diagram of an example processor and/or System on a Chip (SoC) that may have one or more cores and an integrated memory controller.

FIG. 13(A) is a block diagram illustrating both an example in-order pipeline and an example register renaming, out-of-order issue/execution pipeline according to examples.

FIG. 13(B) is a block diagram illustrating both an example in-order architecture core and an example register renaming, out-of-order issue/execution architecture core to be included in a processor according to examples.

FIG. 14 illustrates examples of execution unit(s) circuitry.

FIG. 15 is a block diagram of a register architecture according to some examples.

FIG. 16 illustrates examples of an instruction format.

FIG. 17 illustrates examples of an addressing information field.

FIG. 18 illustrates examples of a first prefix.

FIGS. 19(A)-(D) illustrate examples of how the R, X, and B fields of the first prefix in FIG. 18 are used.

FIGS. 20(A)-(B) illustrate examples of a second prefix.

FIG. 21 illustrates examples of a third prefix.

FIG. 22 is a block diagram illustrating the use of a software instruction converter to convert binary instructions in a source instruction set architecture to binary instructions in a target instruction set architecture according to examples.

### DETAILED DESCRIPTION

Embodiments of the invention provide performance cost (e.g., time. latency) information for monitored events. In embodiments, existing performance monitoring architectures (e.g., PEBS from Intel Corporation, Instruction Based Sampling (IBS) from AMD Corporation, Statistical Profiling Extension from ARM) may be extended by using memory buffers (e.g., in PEBS) or processor registers (e.g., in IBS). to provide time in addition to the information (e.g., instruction pointer, data address) collected for monitored events.

For convenience and to provide examples, this specification may use the term “PEBS” and/or “timed PEBS” in descriptions of embodiments; however, embodiments are not limited to PEBS or using time to measure performance cost.

For example, for MEM_LOAD_RETIRED.L3_HIT, the time would be the retirement push-out induced by the instruction to which the load that hit in the level 3 (L3) cache belongs. Embodiments may allow software to sort samples of an event based on its impact to the overall performance. For example, a load that hit an L3-cache that is part of a sequential access pattern is less likely to impact performance than a load that is part of a random access pattern.

Embodiments may provide precise performance cost in the number of elapsed retirement cycles, which may be preferred over approaches that provide some bucketing (e.g., per load data-source or branch mispredict type) that may indirectly point to range of potential cost.

Embodiments may provide cost at instruction level granularity, e.g., the performance cost for the particular instruction for which the event fires, which may be preferred over approaches that may do so for a sequence of instructions with no taken branches (sometimes called “hyper-block” which may be a quite long sequence of instruction) for some compiler generated codes.

Embodiments may provide top-down oriented cost, e.g., by adding performance cost information to generic events (e.g., INST_RETIRE.ANY, BR_MISP_RETIRED.ALL_BRANCHES, ASSISTS.ANY) which may be preferred over approaches with a small number of precise events in a bottom-up fashion that may limit the ability to cover a spectrum of performance.

Embodiments may provide sampling without blind spots because a time cost may be providing for any precise event for any of its occurrences, which may be preferred over approaches that pre-select certain transactions for monitoring each time.

Embodiments may be used to optimize a software stack and tune software to hardware, for example by measuring the performance cost of instruction cache misses such that the cost of instruction cache misses may be mitigated by inserting of software prefetch instructions.

### PRECISE AND NON-PRECISE EVENT BASED SAMPLING (PEBS AND NPEBS)

The performance monitoring capability employed in some embodiments may be built upon three sets of event counters: fixed function counters, general purpose counters, and timed PEBS counters. In embodiments, three fixed function counters may be defined and implemented to count instructions retired, reference clocks, and core clocks. The general-purpose counters and timed PEBS counters may be defined and implemented as described below. In embodiments, any number of general-purpose counters may each be associated with a corresponding timed PEBS counter. In embodiments, any number of timed PEBS counters may be available for use in connection with monitoring events (e.g., Load STLB hit) that may not be defined and/or selectable as PEBS events according to a previous PEBS architecture.

As used herein, a precise event is a performance event that is linked to a specific instruction or micro-operation in an instruction trace and occurs when that instruction or micro-operation retires. Such precise events may include, but are not limited to, instructions retired, branch instructions retired, cache references, or cache misses, to name just a few examples. On the other hand, a non-precise event is a performance event that is either not linked to a specific instruction or micro-operation in an instruction trace or can occur speculatively even when the instruction or micro-operation does not retire. By way of example, a non-precise event may include, but is not limited to, reference clock ticks, core clock ticks, cycles when interrupts are masked, to name just a few examples.

In some embodiments, performance of a processing device is monitored to manage events and measure their impact on performance. In some embodiments, the processing device tracks precise and non-precise events and stores architectural and micro-architectural metadata regarding the events in a non-intrusive manner utilizing a mechanism on the processing device without the intervention of a performance monitoring interrupt (PMI).

The operation of a processing device may include the occurrences of a plurality of events that monitor performance of the system. An event may include any operation, occurrence, or action in a processor. In embodiments, the event is a response to a given instruction and data stream in the processing device. The events may be associated with architectural metadata including state information of the processing device including, but not limited to, an instruction pointer, a time stamp counter, and register state. The events may also be generic events (e.g., INST_RETIRED) that may be tagged with a performance cost.

In embodiments, a performance counter is configured to count one or more types of events. While the counter is incrementing or decrementing, software reads the counter at selected intervals to determine the number of events that have been counted between the intervals. The counter may be implemented in multiple ways. In embodiments, the counter decrements from a positive starting value, overflowing when the count reaches zero. In other embodiments, the counter starts at a zero value and increments the count of occurrences until it overflows at a specified value. In other embodiments, the counter starts at a negative value, and increments until it overflows upon reaching zero. The performance counter may generate a performance record or a performance monitoring interrupt (PMI) when the counter overflows. To trigger an overflow, the counter may be preset to a modulus value that may cause the counter to overflow after a specific number of events have been counted, which generates either a PMI or a performance record, such as a precise event based sampling (PEBS) record.

A performance record, as further described below, may include a performance cost or penalty metric that would help to rank criticality of events to performance. In embodiments, the cost may be measured in the retirement push-out time induced by the event.

Embodiments may include new (e.g., not defined and/or selectable as PEBS events according to a previous PEBS architecture) precise events (e.g., for STLB-hit retired load/stores, BR_MISP_RETIRED.PLUS_ONE (fires on the first instruction after a branch misprediction) and/or upgrading events (MACHINE_CLEARS) to precise.

### TRACKING PRECISE EVENTS

There are several types of mechanisms for monitoring and managing various events. One type is a PEBS mechanism, which functions to monitor and manage precise events. A precise event is a performance event that is linked to a specific instruction or micro-operation in an instruction trace and occurs when that instruction or micro-operation retires. Such precise events may include, but are not limited to, instructions retired, branch instructions retired, cache references, or cache misses, to name just a few examples. The PEBS mechanism may include several components, such as an event select (ES) control, a performance counter, a PEBS enable circuit and a PEBS handler circuit. The ES control may be programmed with an event identifier, which causes a performance counter corresponding to the ES control to start tracking (e.g., counting occurrences of) the programmed event corresponding to the event identifier.

Embodiments may also include a PEBS enable circuit of the processing device that controls when a PEBS record is generated. When the PEBS enable circuit is activated, a PEBS record is stored in a memory of the PEBS handler circuit upon overflow of the performance counter corresponding to the PEBS enable circuit. In embodiments, a user (e.g., software) may activate or set the PEBS enable circuit. A PEBS record may include architectural metadata of a state of the system upon the overflow of the performance counter. Such architectural metadata may include, but is not limited to, an Instruction Pointer (IP), Time Stamp Counter (TSC) and register state. As such, the PEBS record not only allows the location of the precise events in the instruction trace to be accurately profiled, but also provides additional information for use in software optimization, hardware optimization, performance tuning, etc.

A PEBS record may also include micro-architectural information that may measure the performance cost of events. For example, in the case of MEM_LOAD_RETIRED.L3_MISS (demand load accesses missing the L3 cache), the PEBS record may include a performance cost or penalty metric that would help to rank criticality of misses at different IPs.

### TRACKING NON-PRECISE EVENTS

Embodiments may further utilize the PEBS mechanism to track and manage non-precise events of a processing device. A non-precise event is a performance event that is either not linked to a specific instruction or micro-operation in an instruction trace or can occur speculatively even when the instruction or micro-operation does not retire. Byway of example, a non-precise event may include, but is not limited to, reference clock ticks, core clock ticks, cycles when interrupts are masked, and so on.

Some embodiments introduce a non-precise event based sampling (NPEBS) handler circuit of the processing device that allows an NPEBS handler circuit to generate a NPEBS record for programmed non-precise events and stores this NPEBS record for the non-precise event in the PEBS memory buffer of the PEBS handler circuit.

In embodiments, the NPEBS record shares the same format as the PEBS record. In other embodiments, the NPEBS record is formatted differently from the PEBS record.

The PEBS handler circuit and the NPEBS handler circuit may share some circuitry. The NPEBS handler circuit may use the resources of the PEBS handler circuit, differing from the PEBS handler circuit only in name. In an example, when the ES control is programmed with a non-precise event identifier, the performance counter associated with the ES control and the PEBS enable circuit tracks the programmed non-precise event. In embodiments, the NPEBS handler circuit is coupled to the PEBS enable circuit, which is coupled to the performance counter such that when the performance counter overflows, the PEBS enable circuit causes the NPEBS handler circuit to generate the NPEBS record for the non-precise event. Accordingly, the architectural metadata associated with the non-precise event is captured without requiring a PMI.

In embodiments, the NPEBS handler circuit controls timing of the generation of the NPEBS record for the non-precise event. In embodiments, the NPEBS record for the non-precise event is generated immediately upon occurrence of the overflow of the performance counter tracking the non-precise event. In other embodiments, the NPEBS record for the non-precise event is generated immediately after the occurrence of the overflow of the performance counter tracking the non-precise events (e.g., upon execution of next subsequent instruction). In embodiments, the NPEBS handler circuit stores the NPEBS record for the non-precise event in memory storage of the NPEBS handler circuit.

Some embodiments include compact circuits, and therefore are implemented as an integral part of a wide range of processing units without incurring significant increase of cost and power consumption. Some embodiments are programmable circuit logics and are used to track and manage different types of non-precise events on the same circuit logic. The NPEBS handler circuit is also extensible to track multiple processing units. The NPEBS handler circuit may be shared by a plurality of applications running on a same processor and managed by an operating system (OS) or a virtual machine as a shared resource.

### EXEMPLARY PROCESSOR TO GENERATE AND STORE PEBS AND NPEBS RECORDS

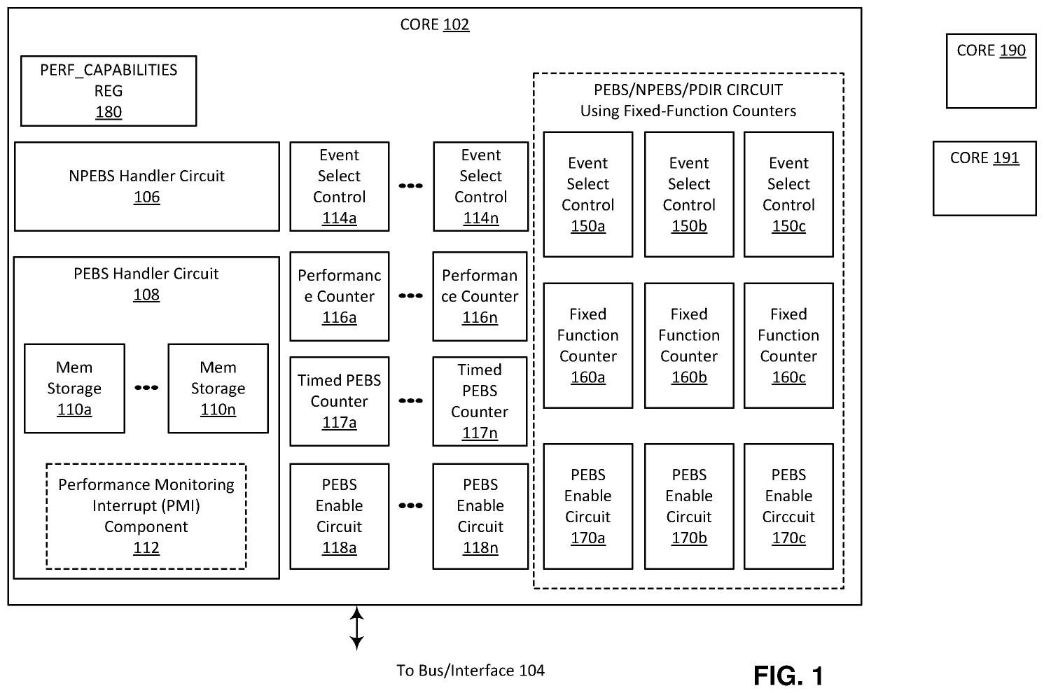

FIG. 1 is a block diagram illustrating a processor to generate and store PEBS and NPEBS records according to embodiments. Any or all of the blocks shown in FIG. 1 may represent circuitry and/or logic in a performance management unit (PMU) of the processor.

In some examples, the PMU supports timed PEBS and a hybrid enumeration architecture via CPUID.

A CPUID leaf enhances enumeration of PMU capabilities. In particular, in some examples, CPUID sub-leafing accommodates future PMU extensions, hybrid resources are exposed per core-type, a bitmap hybrid enumeration of general counters availability is used, a bitmap hybrid enumeration of fixed counters availability is used, and new architectural PMU capabilities can be exposed via CPUID.

In FIG. 1, a core 102 of a multicore processor (e.g., having one or more performance core(s) and one or more efficiency core(s)—other cores 190 and 191 are shown and they may be either performance or efficiency) includes an NPEBS handler circuit 106 and a PEBS handler circuit 108 having one or more memory storages 110a to 110n (which may be implemented as physical memory storage such as a buffer). The PEBS handler circuit 108 may also include a performance monitoring interrupt (PMI) component 112 as described above. In addition, the processor 102 may include one or more event select (ES) controls 114a to 114n corresponding to one or more general purpose performance counters 116a-116n and further corresponding to one or more PEBS enable circuits 118a-118n (details of which are described above). In some implementations, PEBS enable circuits 118a-118n may be located in a single control register (e.g., machine specific register or MSR). In some examples, the performance core(s) and efficiency core(s) share an instruction set architecture. In some examples, the performance core(s) and efficiency core(s) have different instruction set architectures.

In addition, in the embodiment shown in FIG. 1, PEBS, NPEBS, and Precise Distribution of Instructions Retired (PDIR) operations are applied using fixed function counters 160a-c. In embodiments, the three fixed function counters 160a-c are defined and implemented to count instructions retired, reference clocks, and core clocks. Itwill be appreciated, however, that the underlying principles of the invention are not limited to any particular number of fixed function counters or any particular fixed function counter implementation.

As mentioned, the processor 102 may execute a stream of instructions that may be embedded with markers for events that may be placed on a bus/interconnect fabric 104. The execution of a segment of instructions may constitute one or more non-precise events. A non-precise event is a performance event that is either not linked to a specific instruction or micro-operation in an instruction trace or can occur speculatively when the instruction or micro-operation does not retire. Such non-precise events may include, but are not limited to, reference clocks, core clocks and cycles, to name a few examples. In embodiments, the non-precise event is generated by the processor 102. In embodiments, the non-precise event is generated outside the processor 102 and communicated to the processor via the bus/interconnect fabric 104.

In embodiments, event select (ES) controls 150a-c shown in FIG. 1 perform similar operations to ES controls 114a-c described above but correspond to the fixed function performance counters 160a-c and further correspond to PEBS enable circuits 170a-c associated with the fixed function counters 160a-c. In embodiments, the PEBS enable circuits 118a-118n and 170a-c are located in a single control register.

In one embodiment, the programming of the ES controls 150a-c causes a performance counter 160a-c corresponding to the programmed ES control to track occurrences of the particular programmed non-precise/precise event. In some embodiments, any event that is not defined as a precise event is considered a non-precise event. In one embodiment, the ES control 150a-c is programmed by an executing application. In another embodiment, a user programs the ES control 150a-c with the non-precise/precise event identifier.

When the ES control 150a-c is programmed with an event identifier, the performance counter 160a-c corresponding to the ES control 150a-c is incremented or decremented upon each occurrence of the programmed event. The PEBS enable circuit 170a-c corresponding to the ES control 150a-c and the fixed function performance counter 160a-c may be set (e.g., activated, flag set, bit set to 1, etc.) to generate a PEBS record upon overflow of the fixed function performance counter 160a-c or, if the counter is decremented, upon the fixed function performance counter 160a-c reaching a value of 0.

In one embodiment, PEBS enable bits are set to enable the PEBS handler circuit 108 to generate a PEBS record upon overflow or zero value of the fixed function performance counter 160a-c that is counting the event. As discussed above, a PEBS record includes an architectural metadata of a state of the system upon the overflow or zero value of the fixed function performance counter 160a-c. The architectural metadata may include, but is not limited to, an IP, TSC, or register state, for example.

In one embodiment, the NPEBS handler circuit 106 is coupled to the PEBS enable circuit 170a-c such that when the fixed function performance counter 160a-c overflows or reaches a zero value, the NPEBS handler circuit 106 causes the PEBS enable circuit 170a-c to generate the PEBS record for the event. In some embodiments, the NPEBS handler circuit 106 controls timing of generation of the PEBS record for the event. For example, in one embodiment, the NPEBS handler circuit 106 causes the PEBS enable circuit 170a-c to generate the PEBS record for the event immediately upon occurrence of the overflow or zero value of the performance counter 160a-c, tracking and counting the programmed event.

In another embodiment, the NPEBS handler circuit 106 causes the PEBS enable circuit 170a-c to generate the PEBS record for the event immediately after the occurrence of the overflow or zero value of the fixed function performance counter 160a-c, tracking and counting the programmed event. In this embodiment, the PEBS record is generated after the next instruction that retires (i.e., after completion of the next instruction in the instruction trace that triggered the fixed function performance counter 160a-c to overflow or run to zero). In one embodiment, the PEBS record generated for the event by PEBS handler circuit 108 is stored in memory storage 110 of the PEBS handler circuit 108. Accordingly, the architectural metadata associated with the event may be captured without utilizing a PMI.

In one embodiment, the PMI component 112 collects the PEBS records stored in the memory storage(s) 110a-110n of PEBS handler circuit 108. The PMI component 112 may immediately collect the PEBS records stored in the memory storage 10a-110n. In another embodiment, the PMI component 112 is delayed in collecting the PEBS records in memory storage 1110a-1110n at once. The interface may be provided as an MSR.

Applying PEBS/NPEBS/PDIR to the fixed function counters 160a-c provides similar benefits as adding those features to the general-purpose counters 116a-n, but allows for the freedom to use the general-purpose counters for other activities. These and other benefits and additional features of the embodiments of the invention are discussed below.

A performance capabilities control register 190 (e.g., IA32_PERF_CAPABILITIES MSR) enhances enumeration for PMU non-architectural features. For hybrid parts, this register 190 includes a per-field attributed to indicated whether the reporting is common or hybrid across core-types. An example format is as follows.

| Field Name | Bits | Type |
|---|---|---|
| LBR FMT | 5:0 | Common |
| PEBS Trap | 6 | Common |
| PEBS Arch Regs | 7 | Common |
| PEBS FMT | 11:8 | Common |
| Freeze while SMM | 12 | Common |
| Full Write | 13 | Common |
| PEBS Baseline | 14 | Common |
| Perf Metrics Available | 15 | Hybrid |
| PEBS Output PT Available | 16 | Hybrid |
| PEBS Timing Info | 17 | Common |
| TSX Store Address Register | 18 | Hybrid |
| RDPMC Clear Metrics | 19 | Hybrid |

### EXEMPLARY ROCESS FOR GENERATING AND STORING PEBS RECORDS

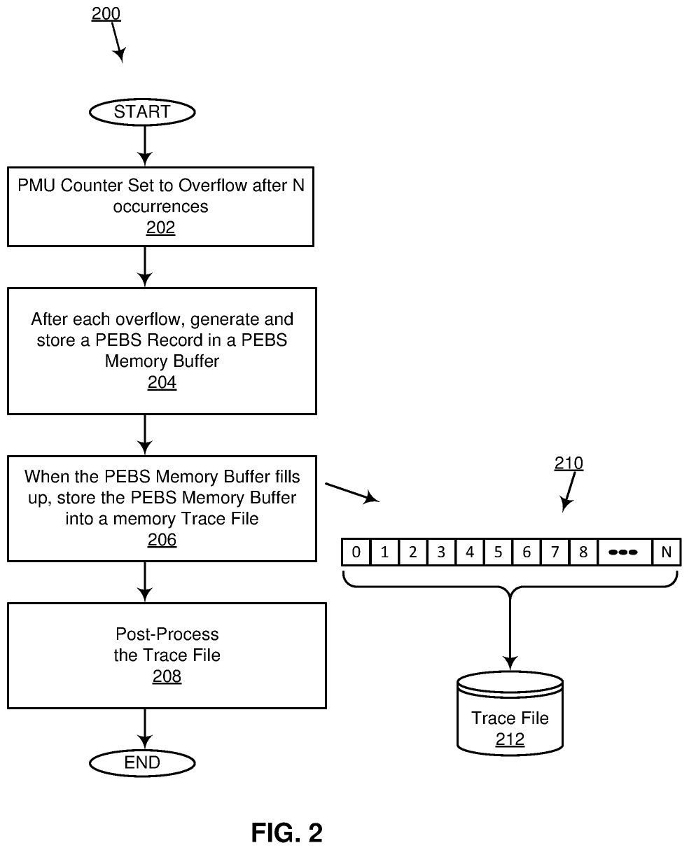

FIG. 2 illustrates an embodiment of a process to generate and store PEBS records in a memory buffer, and to store the memory buffer to a PEBS trace file. After starting, at 202 a PMU counter is set to −N. Starting at a negative value, the PMU counter in this embodiment is to be incremented every time a PEBS record is generated, until it reaches zero (0). In an alternate embodiment, not shown, the PMU counter is set to +N, and decremented every time a PEBS record is generated. At 204, N PEBS records are generated and stored in a PEBS memory buffer. At 206, the N PEBS records are stored in a PEBS trace file. This step is also illustrated as 210, showing N PEBS records being stored in a PEBS trace file 212. At 208, the PEBS trace file is post-processed, after which the process ends.

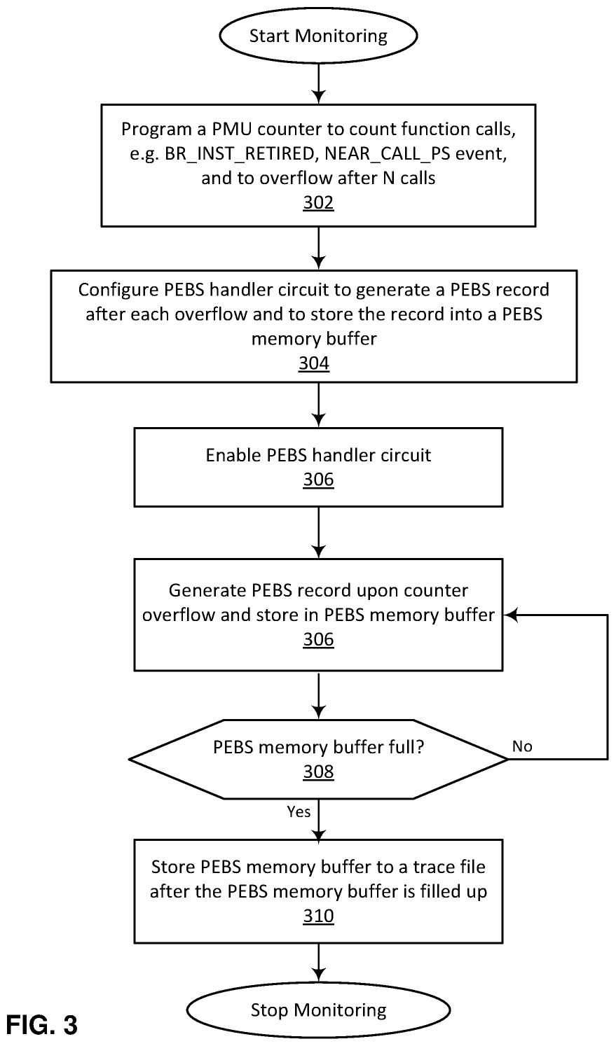

FIG. 3 illustrates an embodiment of a process of programming a PEBS handler circuitto monitor processor performance and generate a PEBS record to be stored in a PEBS memory buffer, and then stored in a PEBS trace file. After starting, at 302 a PMU counter is programmed to count function calls, such as BR_INST_RETIRED and NEAR_CALL_PS event, and to overflow after N calls. At 304, the PEBS handler circuit is programmed to generate, after each overflow, a PEBS record configured to contain architectural metadata including state information of the processor including, but not limited to, an instruction pointer, a time stamp counter, and register state, as well as performance cost. Configuration of the processor information monitored by PEBS and stored in a PEBS data record. At 306, after the PEBS memory has been filled up, the PEBS memory contents are stored to a PEBS trace file. The process then ends.

### EXEMPLARY METHOD AND HARDWARE/FIRMWARE TO ADD PERFORMANCE COST TO PEBS RECORDS

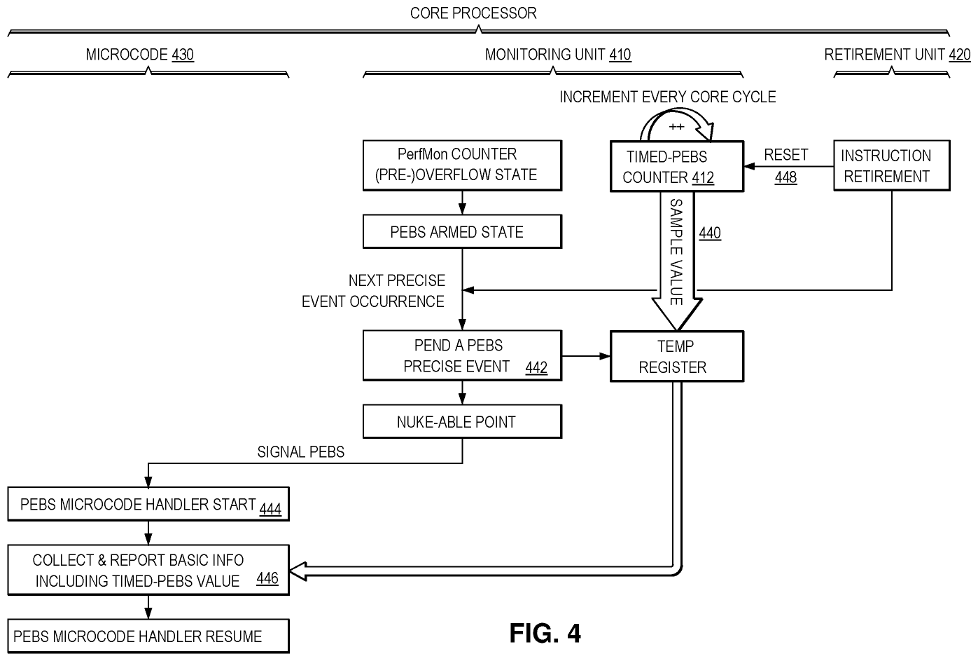

FIG. 4 illustrates an embodiment of a method using a hardware and firmware to add performance cost to sampling (e.g., PEBS) records. As shown in FIG. 4, PMU 410 (which may include any or all of the blocks shown in processor 102 as shown in FIG. 1 and/or correspond to a PMU according to the description of FIG. 1), retirement unit 420, and firmware/microcode 430 collaborate in order to provide the performance cost. One or more timed counters (e.g., 412 and/or timed PEBS counters 117a-117n in FIG. 1) may be included in a PMU to count the duration between retirement of instructions.

At 440, the counter value may be sampled when (at 442) sampling (e.g., PEBS) is pended (and right before its reset due to the same instruction retirement). At 446, microcode may read this sampled value and write it to the memory resident record similar to how it reports other information such as the IP.

In embodiments, the timed counter may be a 16-bit counter added to a reorder buffer (ROB) such that it may measure time by counting clock cycles (e.g., MCLKs) between retirement of instructions. For example, at 448, it may be resetwhen an instruction retires (e.g., EOM flow marker). In embodiments, it may be enabled/disabled based on one or more settings and/or indicators to enable/disable sampling (e.g., PEBS) and/or performance monitoring (e.g., PMonThreadsActive is set). In embodiments, it may saturate at all ones.

In embodiments, the ROB may save a snapshot of the timed counterto a per-thread register (e.g., a control register) when sampling (e.g., for a corresponding event) is pended, cleared (e.g., MoNukeOnPebs), and/or both (e.g., the earliest of them). In embodiments, at 444, microcode may be invoked to store that register's value to the corresponding record.

### Hybrid PMU Enumeration

In some examples, heterogenous (hybrid) architectures are used meaning a processor, SOC, etc. are composed of multiple CPU types (i.e., architectural designs).

These individual CPUs are referred to as cores. Heterogenous architectures provide significant benefits in terms of performance and power consumption, however they present new complexities. Each core type, being based on different architectures, could have a different set of features including different Performance Monitoring Unit (PMU) implementations with different capabilities.

As an example, some processors contain a combination of some performance cores and some efficiency cores, with the two types having different performance monitoring (hereby referred to as PM) capabilities. One of these capabilities is PM counters, which are individual registers in the CPU used for telemetry. The number of PM counters could differ between each core types. At the application space (i.e., Performance Monitoring Software), measurements from these counters are combined using various formulae to create performance metrics. The existing methods of enumeration of PM capabilities cannot simultaneously represent the capabilities of the different types of cores.

Hence, enumeration structures in the architecture currently present the minimum set of counters available in all core types. This results in significant loss of performance analysis capabilities in the platform to the cores with greater than the minimum number of counters.

To address the problem of Performance Monitoring a few solutions have been implemented, none of which are sufficient to enable full performance analysis capabilities:
1. Enumerate the minimum number of counters across all core types: This solution has the limitation of using a reduced set of counters common to all core types in the system causing suboptimal performance monitoring capabilities.
2. Maintain a database within the performance monitoring software listing the PM capabilities of all types of CPUs: This solution relies on identifying the CPU model information (i.e. “family, model and stepping”) and keeping track of the PM capabilities available on each CPU model instead of querying the processor for the same information. This solution allows software to utilize different PM capabilities for each core type but incurs the high burden of maintaining and updating the database for each CPU model. As the number of supported CPU models increases it becomes impractical to reliably maintain PM software tools. Furthermore, the approach becomes unusable for user space PM tools if Operating Systems and Hypervisors expose only CPU enumerated features and do not update the database at the same cadence as user space PM software tools.

Examples detailed herein provide for enumerating capabilities of a PMU in hybrid architectures through a new CPUID (a mechanism CPU vendors provide to system software to enumerate CPU features) Leaf to allow system software to leverage the full set of Performance Monitoring capabilities across all core types on heterogenous systems.

The solution outlined in this invention ensures that software can query the hybrid platform for the PM capabilities of each of its core types separately. This overcomes the existing limitations on exposing Performance Monitoring capabilities in hybrid SoC to OS and software tools. This solution does not rely on a common set of counters used by previous approaches and does not require software developers to maintain a database of PM capability for each CPU model in their PM software. Furthermore, the enumeration mechanism seamlessly works along the existing homogenous CPUID enumeration of PM features and hence allows legacy software to continue working as expected.

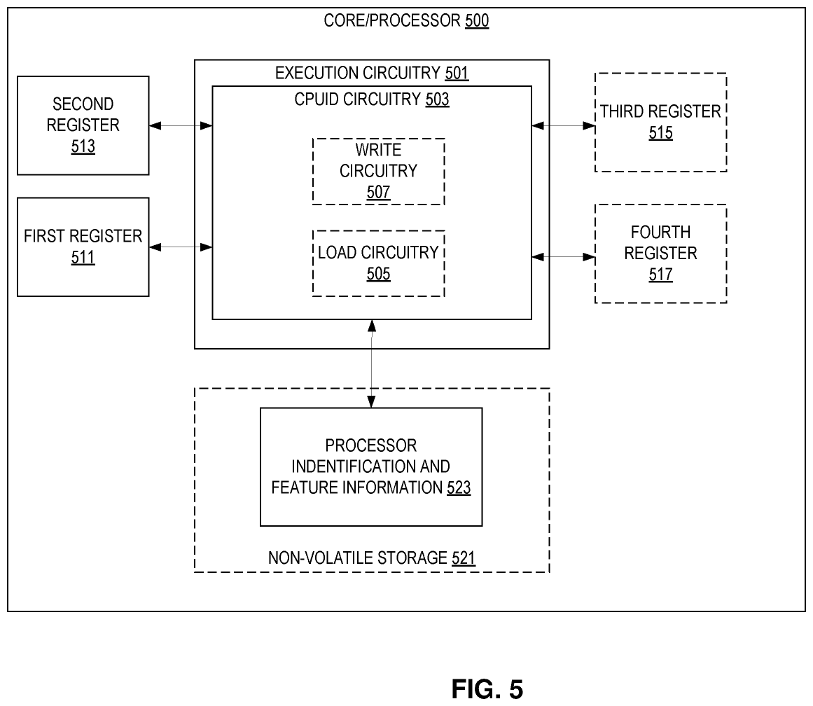

FIG. 5 illustrates examples of CPUID instruction execution. As shown, the core/processor 500 includes execution circuitry 501 to perform one or more actions in response to a decoded single processor identification and feature information instruction. In some examples, the opcode is 0F A2H and/or the mnemonic is CPUID.

CPUID circuitry 503 access processor identification and feature information 523 from storage (e.g., non-volatile storage 521 (e.g., read only memory, etc.) that includes capabilities of the core/processor 500. In some examples, one or more registers, written before the CPUID instruction, provide an indication of what is to be written. In some examples, a first register used for that indication is EAX. In some examples, a second register used for that indication is ECX. In some examples, the first and/or second register are implicit (that is they are not explicitly identified by the instruction's encoding). In some examples, the first and/or second register are explicit (that is they are explicitly identified by the instruction's encoding). In some examples, load circuitry 505 loads or retrieves this data from one or more storage locations based on the one or more registers.

The loaded or retrieved processor identification and feature information, including capabilities, is then written to one or more registers (e.g., first register 511, second register 513, third register 515, and/or fourth register 515. In some examples, write circuitry 507 performs this/these write(s).

A CPUID leaf 23H (35 in decimal) can be used by PM software to find out which PM counters are present on each core and configure performance monitoring capabilities on each core independently to get the full set of performance information from each core. In some example, PM software should however first read CPUID leaf 0 to find out the number of CPUID leaves available on the first core and proceed to use CPUID leaf 23H only if there are at least 23H leaves available.

In some examples, CPUID leaf 23H must be read on each core separately to retrieve a per-core set of available performance counters. The value read is a bitmap where each bit describes the presence or absence of a specific counter. Use of performance counters on each core must be in accordance with the bitmap read from leaf 23H.

For legacy software that does not support CPUID leaf 23H, the CPUID leaf AH (10 in decimal) will continue to report on each core the minimum set of PM counters available across all cores. Hence, legacy PM software is expected to reliably work using CPUID leaf 0xA, as if CPUID leaf 23H did not exist.

The CPUID instruction supports the use of “sub-leaves” for each leaf, which group together related information within the leaf. CPUID leaf 23H leverages the sub-leaf design of CPUID. This means software needs to provide the sub-leaf number along with the leaf number when executing the CPUID instruction. The first sub-leaf within leaf 23H that should be read is leaf 0, which returns the “valid sub-leaves” information. The output will be a bitmap of 32 bits returned in EAX register in the CPU, where each bit describes whether the particular sub-leaf is present or not. For example, bit 0 being 1 means that sub-leaf 0 is present and bit 2 being 0 means that sub-leaf 2 is not present.

The PM counter availability information is present within the sub-leaf 1, given bit 1 in sub-leaf 0 is 1. Sub-leaf 1 will output the number of ‘fixed’ and ‘general-purpose’ counters in two different registers. Each ‘Fixed’ counter always is designed to count a specific performance event (e.g., instructions retired), whereas a ‘general-purpose’ counter can be programmed to count one of several events (e.g., branch mispredictions, cache misses, etc.) during measurement.

In some examples, CPUID leaf 23H also defines the sub-leaf 3. Each bit of the output of sub-leaf 3 indicates the presence or absence of a particular standardized event, referred to as “Arch PerfMon Events”. For example, bit 1 of output of sub-leaf 3 being 1 means that the ‘instructions retired’ event is present in the core. This sub-leaf provides an easy way for hardware to expose the presence of each of such standardized events.

Detailed below are example leaf and sub-leaf contents for 23H

CPUID Leaf 023H Format

| CPUID (EAX = 023H, | | | | |
|---|---|---|---|---|
| ECX = per leftmost column) | | | | |
| ECX | | | | |
| (sub- | | | | |
| leaf) | Register | Bits | Name | Description Behavior |
| 0 | EAX | 31:0 | Valid sub-leaves | For each bit n set in this field, sub-leaf n |
| | | | | under CPUID.023H is supported. |
| | EBX, | 31:0 | Reserved | |
| | ECX, EDX | | | |
| 1 | EAX | 31:0 | General counters | For each bit n set in this field, the |
| | | | bitmap | processor supports general-purpose |
| | | | | performance monitoring counter n. |
| | EBX | 31:0 | Fixed counters | For each bit m set in this field, the |
| | | | bitmap | processor supports fixed-function |
| | | | | performance monitoring counter m. |
| | ECX, EDX | 31:0 | Reserved | |
| 2 | | | Reserved | |
| 3 | EAX | 31:0 | Arch PerfMon Events | For each bit n set in this field, the |
| | | | bitmap | processor supports Architectural |
| | | | | PerfMon Event of index n. |
| | | | | Bit 00: Core cycles. |
| | | | | Bit 01: Instructions retired. |
| | | | | Bit 02: Reference cycles. |
| | | | | Bit 03: Last level cache references. |
| | | | | Bit 04: Last level cache misses. |
| | | | | Bit 05: Branch instructions retired. |
| | | | | Bit 06: Branch mispredicts retired. |
| | | | | Bit 07: Topdown slots. |
| | | | | Bit 08: Topdown backend bound. |
| | | | | Bit 09: Topdown bad speculation. |
| | | | | Bit 10: Topdown frontend bound. |
| | | | | Bit 11: Topdown retiring. |
| | | | | Bits 31-12: Reserved. |
| 3 | EBX, | 31:0 | Reserved | |
| | ECX, EDX | | | |
| 4-31 | | | Reserved | |

General Counters Bitmap

In some examples, when CPUID.(EAX=23H, ECX=01H):EAX reports a bitmap for available general-purpose counters. (CPUID leaf 0AH reports only the total number of general-purpose counters). This capability enables VMX root software to reserve lower-index counters for its own use, while exposing higher index counters to guest software. This is especially important should the general-purpose counters not be fully homogeneous.

Software may utilize the new bitmap reporting, including for detecting the number of available general-purpose counters. To facilitate this transition, the number of general-purpose counters in CPUID leaf 0AH will not go beyond eight, even if the processor has support for more than eight general-purpose counters.

Fixed Counters Hybrid Bitmap

In some examples, when CPUID.(EAX=23H, ECX=01H):EBX reports a bitmap for available fixed counters. (CPUID leaf 0AH reports the common number of contiguous fixed-function counters in addition to a common bitmap of fixed counters availability.)

This capability enables privileged software to expose per core-type enumeration of fixed counters. This is especially important should the fixed counters not be available on all logical processors.

Architectural Performance Monitoring Events Bitmap

In some examples, when CPUID.(EAX=23H, ECX=03H):EAX provides a true-view of per core-type available architectural performance monitoring events. For each bit n set in this field, the processor supports Architectural Performance Monitoring Event of index n (positive polarity).

Conversely, CPUID leaf 0AH provides a maximum common set of architectural performance monitoring events supported by all core types, where if bit n is set, it denotes the processor does not necessarily support Architectural Performance Monitoring Event of index n on all logical processors (negative polarity).

In some examples, CPUID leaf 23H also has the benefit that the system software or PM software can choose to use either the full set of counters or calculate the minimum set across all cores through the logical AND operation and using the resulting set of counters instead. For example, if there are four counters out of which the 1^{st}, 2^{nd} and 4^{th} are available on one core, then the bitmap output from leaf 23H would be 1011 and suppose only 1^{st} and 4^{th} are available on another core, the bitmap output from the second core would be 1001. The result of the AND operation would be 1001, which represents the minimum common set (i.e., the 1^{st} and 4^{th} counters).

In some examples, the PMU supports timed PEBS which enables the recording of time in every PEBS record. It extends PEBS records with timing information in a new “Retire Latency” field that is placed in the Basic Info group of the PEBS record as shown in the table below.

| Offset | Field Name | Bits |
|---|---|---|
| 0x0 | Record Format | [31:0] |
| | Retire Latency | [47:32] |
| | Record Size | [63:48] |
| 0x8 | Instruction Pointer | [63:0] |
| 0x10 | Applicable Counters | [63:0] |
| 0x18 | TSC | [63:0] |

Retire Latency reports the number of elapsed core clocks between the retirement of the current instruction (as indicated by the Instruction Pointer field of the PEBS record) and the retirement of the prior instruction. All ones is reported when the number exceeds 16-bits.

In some examples, the PMU includes performance monitoring events for topdown analysis as shown below. Topdown Microarchitectural Analysis (TMA) may allow for the fixing of heuristics.

| Bit Position in | | | |
|---|---|---|---|
| CPUID.0AH.EBX and | | Event | |
| CPUID.023H.3.EAX | Event Name | Select | UMask |
| 8 | Topdown Backend Bound | A4H | 02H |
| 9 | Topdown Bad Speculation | 73H | 00H |
| 10 | Topdown Frontend Bound | 9CH | 01H |
| 11 | Topdown Retiring | C2H | 02H |

Topdown Backend Bound —Event Select A4H, Umask 02H

This event counts a subset of the Topdown Slots event that were not consumed by the back-end pipeline due to lack of back-end resources, as a result of memory subsystem delays, execution units' limitations, or other conditions. The count is distributed among unhalted logical processors (hyper-threads) who share the same physical core in some examples. Software can use this event as the nominator for the Backend Bound metric (or top-level category) of a Top-down Microarchitecture Analysis method.

Topdown Bad Speculation—Event Select 73H, Umask OOH

This event counts a subset of the Topdown Slots event that were wasted due to incorrect speculation as a result of incorrect control-flow or data speculation. Common examples include branch mispredictions and memory ordering clears. The count may be distributed among impacted logical processors (hyper-threads or SMT threads) who share the same physical core in some examples. Software can use this event as the nominator for the Bad Speculation metric (or top-level category) of the Top-down Microarchitecture Analysis method.

Topdown Frontend Bound—Event Select 9CH, Umask 01 H

This event counts a subset of the Topdown Slots event that no operation was delivered to the back-end pipeline due to instruction fetch limitations when the back-end could have accepted more operations. Common examples include instruction cache misses or x86 instruction decode limitations.

The count may be distributed among unhalted logical processors (hyper-threads) who share the same physical core, in processors that support Intel Hyper-Threading Technology.

Software can use this event as the nominator for the Frontend Bound metric (or top-level category) of the Top-down Microarchitecture Analysis method.

Topdown Retiring—Event Select C2H, Umask 02H

This event counts a subset of the Topdown Slots event that are utilized by operations that eventually get retired (committed) by the processor pipeline. Usually, this event positively correlates with higher performance—for example, as measured by the instructions-per-cycle metric.

Software can use this event as the nominator for the Retiring metric (or top-level category) of the Top-down Microarchitecture Analysis method.

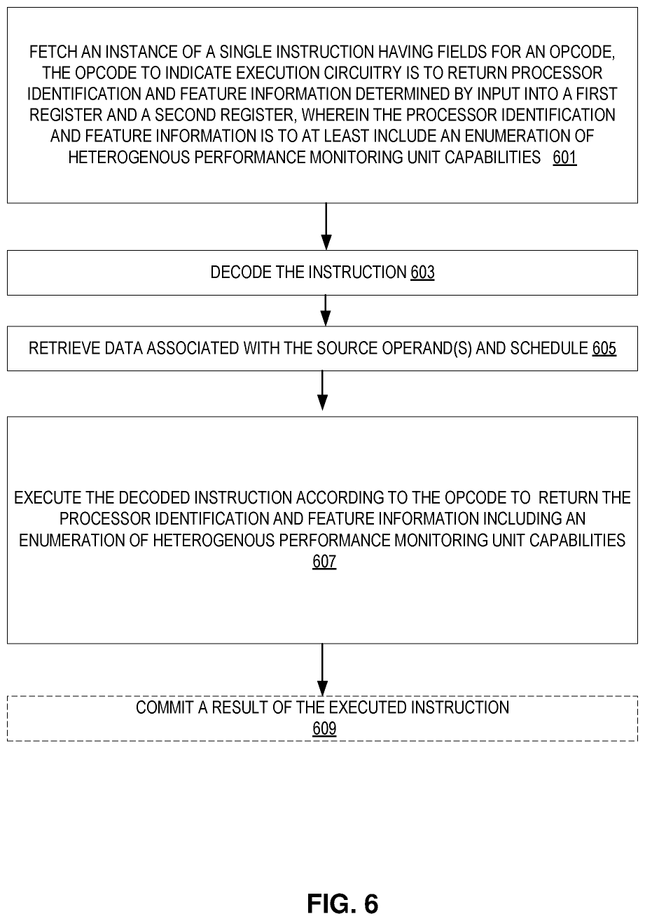

FIG. 6 illustrates an example method performed by a processor to process a processor identification and feature information (CPUID) instruction. For example, a processor core as shown in other figures as detailed herein performs this method.

At 601, an instance of single instruction is fetched. For example, an instruction is fetched. The instruction includes fields for an opcode, single instruction having fields for an opcode, the opcode to indicate execution circuitry is to return processor identification and feature information determined by input into a first register and a second register, wherein the processor identification and feature information is to at least include an enumeration of heterogenous performance monitoring unit capabilities.

The fetched instruction is decoded at 603. For example, the fetched processor identification and feature information instruction is decoded by decoder circuitry such as decoder circuitry 405 or decode circuitry 1340 detailed herein.

Data values associated with the source operands of the decoded instruction are retrieved when the decoded instruction is scheduled at 605. For example, when one or more of the source operands are memory operands, the data from the indicated memory location is retrieved.

At 607, the decoded instruction is executed by execution circuitry (hardware) such as execution circuitry detailed herein. For the processor identification and feature information instruction, the execution will cause execution circuitry to perform the operations described in connection with the opcode to return processor identification and feature information that is to at least include an enumeration of heterogenous performance monitoring unit capabilities.

In some examples, the instruction is committed or retired at 609.

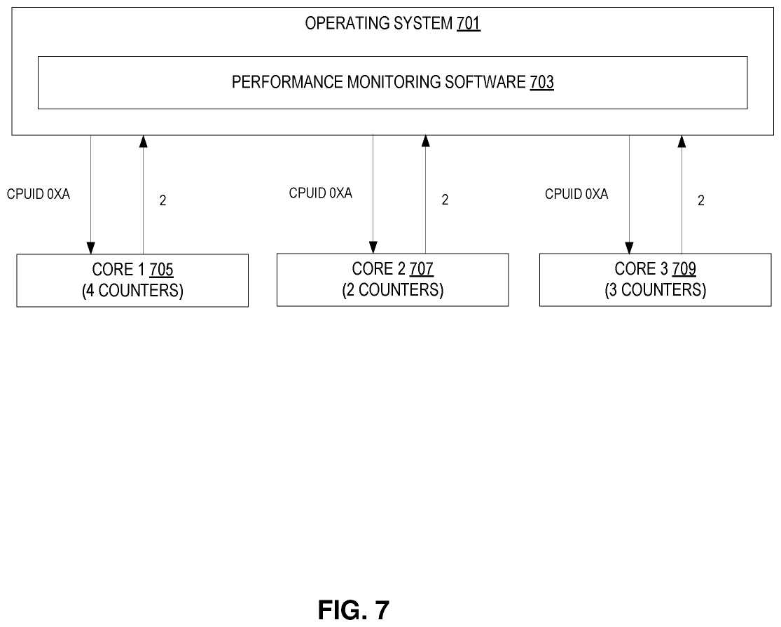

FIG. 7 illustrates an example system configuration with three cores, where Core 1 705 and Core 3 709 have 4 counters each and Core 2 707 has only 2. There is a PM software 703 running within the Operating System 701 that queries each core for PM counters using a legacy CPUID leaf 0xA. Due to the limitation of CPUID leaf 0xA, it receives the output from each core as 2 counters, which is the minimum common set across the cores.

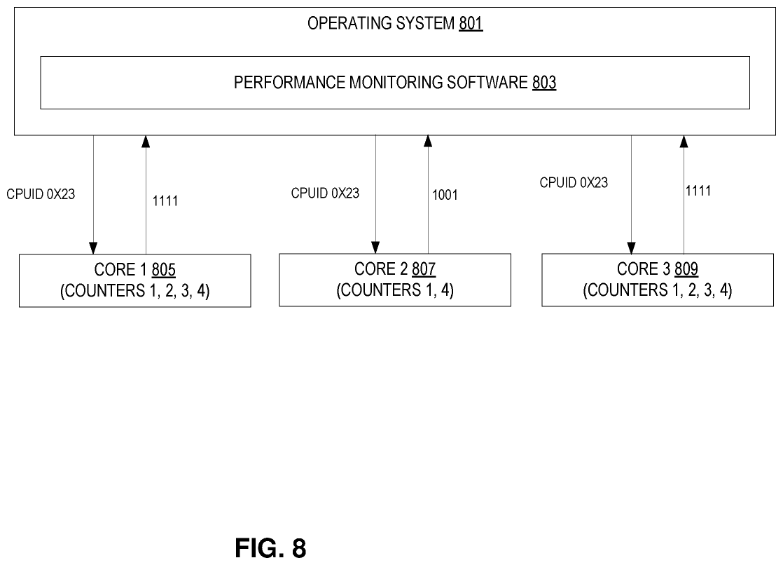

FIG. 8 illustrates an example system configuration with three cores, where Core 1 805 and Core 3 809 have 4 counters each and Core 2 807 has only 2. PM software 803 if the OS 801 queries CPUID leaf 0x23 instead of 0xA. In this case the output will be a separate bitmap for each core which represents the counters available on that core. For example, 1001 indicates counters 1 and 4 are available, but not 2 and 3.

A challenge may be the enumeration of performance monitoring features in virtualized environments (i.e., when a hypervisor or virtual machine monitor (VMM) is used). This means operating systems and PM software do not have full access to system resources, and instead the hypervisor has full control of system resources. In such cases, the hypervisor will be the one to first query each core to discover the set of PM counters. Since CPUID leaf 0xA only reads the minimum set of counters on the core, the hypervisor is restricted to enumerating and exposing only those counters to the Operating System, but with CPUID leaf 0x23 it has access to the full set of PM counters from each core.

Hypervisors are built to enable multiple OSes to run simultaneously on the same system and give them different privileges based on the security needs. Thus, using CPUID leaf 0x23 the hypervisor can choose to expose a) the full set of counters from each core to a privileged and trusted OS, b) the minimum common set to another by calculating the logical AND method described above, or c) to an unprivileged or untrusted OS, it can choose to expose no counters. The PM software in each OS will have access only to the set of counters that the hypervisor has exposed to it.

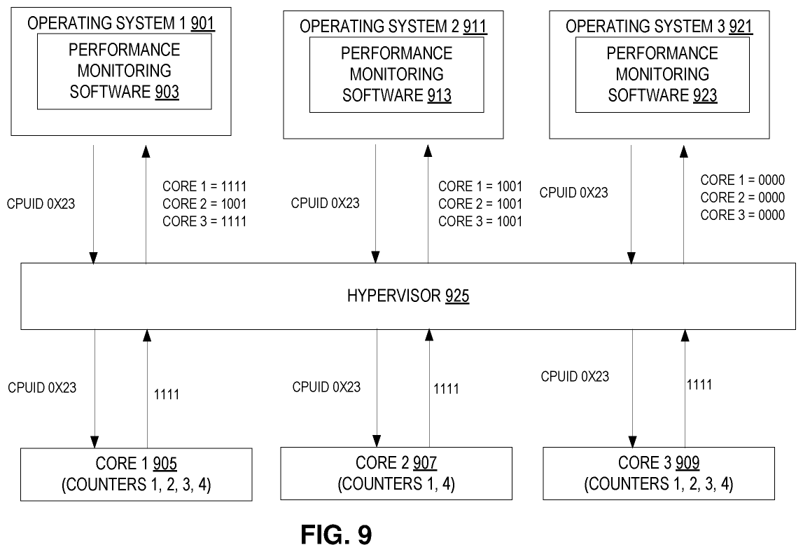

FIG. 9 illustrates an example system with shows three OSes running simultaneously on a system with hypervisor (i.e., virtualization enabled). OS 1 901 runs with max privilege (i.e., fully trusted), OS 2 911 with medium privilege, and OS 3 921 with least privilege (i.e., untrusted). These privilege levels are established for the OS by hypervisor based on its own policy. Each of the OSes is shown to be running PM software (PM software 903, 913, and 923). The hypervisor 925 first queries each core (905, 907, and 909) separately using CPUID leaf 0x23 to obtain the bitmask of PM counters from each of them. Typically, the hypervisor 925 saves these values to memory. When the PM software 1 903 running in the most privileged Operating System 1 901 queries CPUID leaf 0x23 on each core separately, the hypervisor 925 will intercept each of these requests, and return the complete bitmask values for each core that were saved earlier. This means it will respond with 1111 to the requests from core 1 and core 3, and 1001 to the request from core 2, which is the complete set of PM counters on each of the cores. When the PM software 2 913 running in the medium privileged Operating System 2 911 queries CPUID leaf 0x23 on each core separately, the hypervisor 925 responds with the same value on all cores 1,2 and 3, which is the bitmask 1001 which is the minimum common set, because of the medium privileged OS. When the PM software 3 923 running in the least privileged Operating System 3 921 queries CPUID leaf 0x23 on each core separately, the hypervisor should respond with 0000, i.e., no access to any PM counters, for all the cores 1,2 and 3.

CPUID leaf 0x23 allows software to have full view of the PM counters on a heterogenous processor and detectability of standardized events. It also enables software to use a homogenous or heterogenous set of PM counters as appropriate and enables system software to establish privilege levels with each of them allowing the use of a different set of counters.

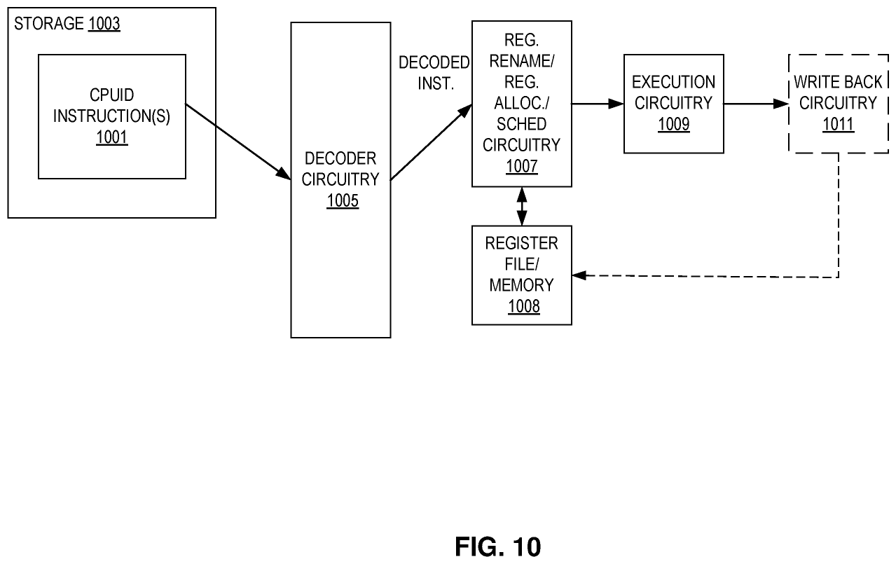

FIG. 10 illustrates examples of computing hardware to process a CPUID instruction. As illustrated, storage 1003 stores a CPUID instruction 1001 to be executed.

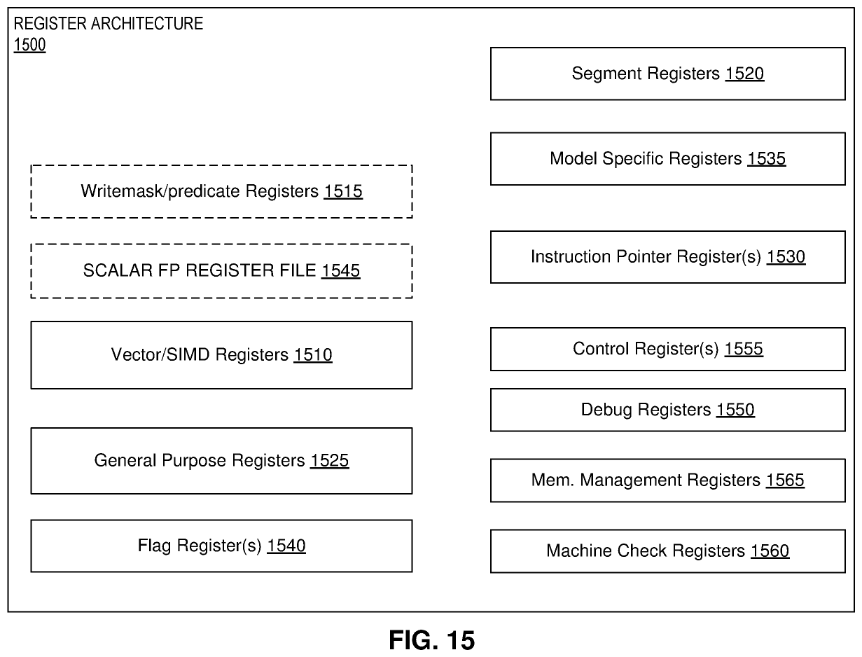

The instruction 1001 is received by decoder circuitry 1005. For example, the decoder circuitry 1005 receives this instruction from fetch circuitry (not shown). The instruction may be in any suitable format, such as that describe with reference to FIG. 16 below. In an example, the instruction includes fields for an opcode and source identifiers.

More detailed examples of at least one instruction format for the instruction will be detailed later. The decoder circuitry 1005 decodes the instruction into one or more operations. In some examples, this decoding includes generating a plurality of micro-operations to be performed by execution circuitry (such as execution circuitry 1009). The decoder circuitry 1005 also decodes instruction prefixes.

In some examples, register renaming, register allocation, and/or scheduling circuitry 1007 provides functionality for one or more of: 1) renaming logical operand values to physical operand values (e.g., a register alias table in some examples), 2) allocating status bits and flags to the decoded instruction, and 3) scheduling the decoded instruction for execution by execution circuitry out of an instruction pool (e.g., using a reservation station in some examples).

Registers (register file) and/or memory 1008 store data as operands of the instruction to be operated by execution circuitry 1009. Example register types include packed data registers, general purpose registers (GPRs), and floating-point registers.

Execution circuitry 1009 executes the decoded instruction. Example detailed execution circuitry includes execution circuitry detailed herein.

In some examples, retirement/write back circuitry 1011 architecturally commits the destination register into the registers or memory 1008 and retires the instruction.

An example of a format for CPUID instruction is CPUID SRC1, SRC2. In some examples, OPCODE is the opcode mnemonic of the instruction. SRC1 and SRC2 are fields for the source operands, such as packed data registers and/or memory. The sources may be provided at least in part by REG 1744 and/or R/M 1746.

Additional examples of architectures, processors, cores, SoCs, etc. that support the above are detailed below.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

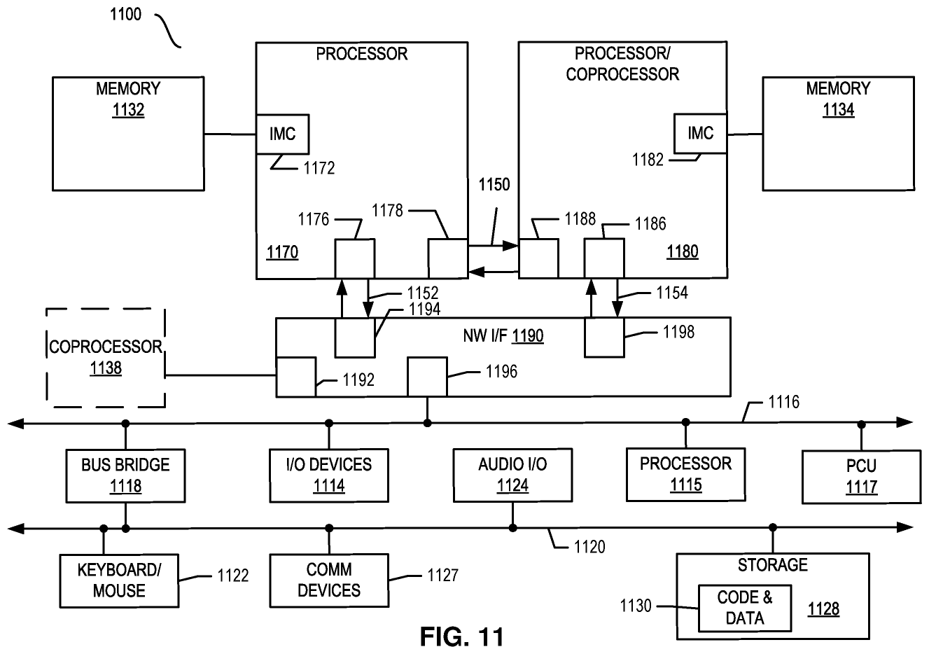

FIG. 11 illustrates an example computing system. Multiprocessor system 1100 is an interfaced system and includes a plurality of processors or cores including a first processor 1170 and a second processor 1180 coupled via an interface 1150 such as a point-to-point (P-P) interconnect, a fabric, and/or bus. In some examples, the first processor 1170 and the second processor 1180 are homogeneous. In some examples, first processor 1170 and the second processor 1180 are heterogenous. Though the example system 1100 is shown to have two processors, the system may have three or more processors, or may be a single processor system. In some examples, the computing system is a system on a chip (SoC).

Processors 1170 and 1180 are shown including integrated memory controller (IMC) circuitry 1172 and 1182, respectively. Processor 1170 also includes interface circuits 1176 and 1178; similarly, second processor 1180 includes interface circuits 1186 and 1188. Processors 1170, 1180 may exchange information via the interface 1150 using interface circuits 1178, 1188. IMCs 1172 and 1182 couple the processors 1170, 1180 to respective memories, namely a memory 1132 and a memory 1134, which may be portions of main memory locally attached to the respective processors.

Processors 1170, 1180 may each exchange information with a network interface (NW I/F) 1190 via individual interfaces 1152, 1154 using interface circuits 1176, 1194, 1186, 1198. The network interface 1190 (e.g., one or more of an interconnect, bus, and/or fabric, and in some examples is a chipset) may optionally exchange information with a coprocessor 1138 via an interface circuit 1192. In some examples, the coprocessor 1138 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1170, 1180 or outside of both processors, yet connected with the processors via an interface such as P-P interconnect, such that either or both processors' local cache information may be stored in the shared cache if a processor is placed into a low power mode.

Network interface 1190 may be coupled to a first interface 1116 via interface circuit 1196. In some examples, first interface 1116 may be an interface such as a Peripheral Component Interconnect (PCI) interconnect, a PCI Express interconnect or another I/O interconnect. In some examples, first interface 1116 is coupled to a power control unit (PCU) 1117, which may include circuitry, software, and/or firmware to perform power management operations with regard to the processors 1170, 1180 and/or co-processor 1138. PCU 1117 provides control information to a voltage regulator (not shown) to cause the voltage regulator to generate the appropriate regulated voltage. PCU 1117 also provides control information to control the operating voltage generated. In various examples, PCU 1117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1117 is illustrated as being present as logic separate from the processor 1170 and/or processor 1180. In other cases, PCU 1117 may execute on a given one or more of cores (not shown) of processor 1170 or 1180. In some cases, PCU 1117 may be implemented as a microcontroller (dedicated or general-purpose) or other control logic configured to execute its own dedicated power management code, sometimes referred to as P-code. In yet other examples, power management operations to be performed by PCU 1117 may be implemented externally to a processor, such as by way of a separate power management integrated circuit (PMIC) or another component external to the processor. In yet other examples, power management operations to be performed by PCU 1117 may be implemented within BIOS or other system software.

Various I/O devices 1114 may be coupled to first interface 1116, along with a bus bridge 1118 which couples first interface 1116 to a second interface 1120. In some examples, one or more additional processor(s) 1115, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1116. In some examples, second interface 1120 may be a low pin count (LPC) interface. Various devices may be coupled to second interface 1120 including, for example, a keyboard and/or mouse 1122, communication devices 1127 and storage circuitry 1128. Storage circuitry 1128 may be one or more non-transitory machine-readable storage media as described below, such as a disk drive or other mass storage device which may include instructions/code and data 1130 and may implement the storage 1003 in some examples. Further, an audio I/O 1124 may be coupled to second interface 1120. Note that other architectures than the point-to-point architecture described above are possible. For example, instead of the point-to-point architecture, a system such as multiprocessor system 1100 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

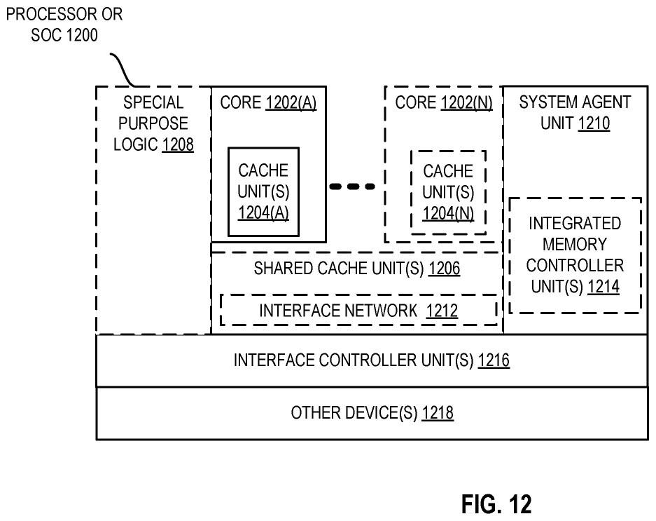

FIG. 12 illustrates a block diagram of an example processor and/or SoC 1200 that may have one or more cores and an integrated memory controller. The solid lined boxes illustrate a processor 1200 with a single core 1202(A), system agent unit circuitry 1210, and a set of one or more interface controller unit(s) circuitry 1216, while the optional addition of the dashed lined boxes illustrates an alternative processor 1200 with multiple cores 1202(A)-(N), a set of one or more integrated memory controller unit(s) circuitry 1214 in the system agent unit circuitry 1210, and special purpose logic 1208, as well as a set of one or more interface controller units circuitry 1216. Note that the processor 1200 may be one of the processors 1170 or 1180, or co-processor 1138 or 1115 of FIG. 11.

Thus, different implementations of the processor 1200 may include: 1) a CPU with the special purpose logic 1208 being integrated graphics and/or scientific (throughput) logic (which may include one or more cores, not shown), and the cores 1202(A)-(N) being one or more general purpose cores (e.g., general purpose in-order cores, general purpose out-of-order cores, or a combination of the two); 2) a coprocessor with the cores 1202(A)-(N) being a large number of special purpose cores intended primarily for graphics and/or scientific (throughput); and 3) a coprocessor with the cores 1202(A)-(N) being a large number of general purpose in-order cores. Thus, the processor 1200 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1200 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1204(A)-(N) within the cores 1202(A)-(N), a set of one or more shared cache unit(s) circuitry 1206, and external memory (not shown) coupled to the set of integrated memory controller unit(s) circuitry 1214. The set of one or more shared cache unit(s) circuitry 1206 may include one or more mid-level caches, such as level 2 (L2), level 3 (L3), level 4 (L4), or other levels of cache, such as a last level cache (LLC), and/or combinations thereof. While in some examples interface network circuitry 1212 (e.g., a ring interconnect) interfaces the special purpose logic 1208 (e.g., integrated graphics logic), the set of shared cache unit(s) circuitry 1206, and the system agent unit circuitry 1210, alternative examples use any number of well-known techniques for interfacing such units. In some examples, coherency is maintained between one or more of the shared cache unit(s) circuitry 1206 and cores 1202(A)-(N). In some examples, interface controller units circuitry 1216 couple the cores 1202 to one or more other devices 1218 such as one or more I/O devices, storage, one or more communication devices (e.g., wireless networking, wired networking, etc.), etc.

In some examples, one or more of the cores 1202(A)-(N) are capable of multi-threading. The system agent unit circuitry 1210 includes those components coordinating and operating cores 1202(A)-(N). The system agent unit circuitry 1210 may include, for example, power control unit (PCU) circuitry and/or display unit circuitry (not shown). The PCU may be or may include logic and components needed for regulating the power state of the cores 1202(A)-(N) and/or the special purpose logic 1208 (e.g., integrated graphics logic). The display unit circuitry is for driving one or more externally connected displays.

The cores 1202(A)-(N) may be homogenous in terms of instruction set architecture (ISA). Alternatively, the cores 1202(A)-(N) may be heterogeneous in terms of ISA; that is, a subset of the cores 1202(A)-(N) may be capable of executing an ISA, while other cores may be capable of executing only a subset of that ISA or another ISA.

### Example Core Architectures—In-Order and Out-of-Order Core Block Diagram

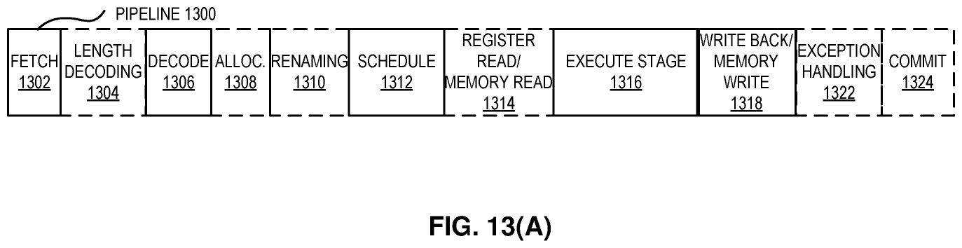

FIG. 13(A) is a block diagram illustrating both an example in-order pipeline and an example register renaming, out-of-order issue/execution pipeline according to examples. FIG. 13(B) is a block diagram illustrating both an example in-order architecture core and an example register renaming, out-of-order issue/execution architecture core to be included in a processor according to examples. The solid lined boxes in FIGS. 13(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 13(A), a processor pipeline 1300 includes a fetch stage 1302, an optional length decoding stage 1304, a decode stage 1306, an optional allocation (Alloc) stage 1308, an optional renaming stage 1310, a schedule (also known as a dispatch or issue) stage 1312, an optional register read/memory read stage 1314, an execute stage 1316, a write back/memory write stage 1318, an optional exception handling stage 1322, and an optional commit stage 1324. One or more operations can be performed in each of these processor pipeline stages. For example, during the fetch stage 1302, one or more instructions are fetched from instruction memory, and during the decode stage 1306, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1306 and the register read/memory read stage 1314 may be combined into one pipeline stage. In one example, during the execute stage 1316, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 13(B) may implement the pipeline 1300 as follows: 1) the instruction fetch circuitry 1338 performs the fetch and length decoding stages 1302 and 1304; 2) the decode circuitry 1340 performs the decode stage 1306; 3) the rename/allocator unit circuitry 1352 performs the allocation stage 1308 and renaming stage 1310; 4) the scheduler(s) circuitry 1356 performs the schedule stage 1312; 5) the physical register file(s) circuitry 1358 and the memory unit circuitry 1370 perform the register read/memory read stage 1314; the execution cluster(s) 1360 perform the execute stage 1316; 6) the memory unit circuitry 1370 and the physical register file(s) circuitry 1358 perform the write back/memory write stage 1318; 7) various circuitry may be involved in the exception handling stage 1322; and 8) the retirement unit circuitry 1354 and the physical register file(s) circuitry 1358 perform the commit stage 1324.

FIG. 13(B) shows a processor core 1390 including front-end unit circuitry 1330 coupled to execution engine unit circuitry 1350, and both are coupled to memory unit circuitry 1370. The core 1390 may be a reduced instruction set architecture computing (RISC) core, a complex instruction set architecture computing (CISC) core, a very long instruction word (VLIW) core, or a hybrid or alternative core type. As yet another option, the core 1390 may be a special-purpose core, such as, for example, a network or communication core, compression engine, coprocessor core, general purpose computing graphics processing unit (GPGPU) core, graphics core, or the like.

The front-end unit circuitry 1330 may include branch prediction circuitry 1332 coupled to instruction cache circuitry 1334, which is coupled to an instruction translation lookaside buffer (TLB) 1336, which is coupled to instruction fetch circuitry 1338, which is coupled to decode circuitry 1340. In one example, the instruction cache circuitry 1334 is included in the memory unit circuitry 1370 rather than the front-end circuitry 1330. The decode circuitry 1340 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1340 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1340 may be implemented using various different mechanisms. Examples of suitable mechanisms include, but are not limited to, look-up tables, hardware implementations, programmable logic arrays (PLAs), microcode read only memories (ROMs), etc. In one example, the core 1390 includes a microcode ROM (not shown) or other medium that stores microcode for certain macroinstructions (e.g., in decode circuitry 1340 or otherwise within the front-end circuitry 1330). In one example, the decode circuitry 1340 includes a micro-operation (micro-op) or operation cache (not shown) to hold/cache decoded operations, micro-tags, or micro-operations generated during the decode or other stages of the processor pipeline 1300. The decode circuitry 1340 may be coupled to rename/allocator unit circuitry 1352 in the execution engine circuitry 1350.

The execution engine circuitry 1350 includes the rename/allocator unit circuitry 1352 coupled to retirement unit circuitry 1354 and a set of one or more scheduler(s) circuitry 1356. The scheduler(s) circuitry 1356 represents any number of different schedulers, including reservations stations, central instruction window, etc. In some examples, the scheduler(s) circuitry 1356 can include arithmetic logic unit (ALU) scheduler/scheduling circuitry, ALU queues, address generation unit (AGU) scheduler/scheduling circuitry, AGU queues, etc. The scheduler(s) circuitry 1356 is coupled to the physical register file(s) circuitry 1358. Each of the physical register file(s) circuitry 1358 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1358 includes vector registers unit circuitry, writemask registers unit circuitry, and scalar register unit circuitry. These register units may provide architectural vector registers, vector mask registers, general-purpose registers, etc. The physical register file(s) circuitry 1358 is coupled to the retirement unit circuitry 1354 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1354 and the physical register file(s) circuitry 1358 are coupled to the execution cluster(s) 1360. The execution cluster(s) 1360 includes a set of one or more execution unit(s) circuitry 1362 and a set of one or more memory access circuitry 1364. The execution unit(s) circuitry 1362 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1356, physical register file(s) circuitry 1358, and execution cluster(s) 1360 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1364). It should also be understood that where separate pipelines are used, one or more of these pipelines may be out-of-order issue/execution and the rest in-order.

In some examples, the execution engine unit circuitry 1350 may perform load store unit (LSU) address/data pipelining to an Advanced Microcontroller Bus (AMB) interface (not shown), and address phase and writeback, data phase load, store, and branches.

The set of memory access circuitry 1364 is coupled to the memory unit circuitry 1370, which includes data TLB circuitry 1372 coupled to data cache circuitry 1374 coupled to level 2 (L2) cache circuitry 1376. In one example, the memory access circuitry 1364 may include load unit circuitry, store address unit circuitry, and store data unit circuitry, each of which is coupled to the data TLB circuitry 1372 in the memory unit circuitry 1370. The instruction cache circuitry 1334 is further coupled to the level 2 (L2) cache circuitry 1376 in the memory unit circuitry 1370. In one example, the instruction cache 1334 and the data cache 1374 are combined into a single instruction and data cache (not shown) in L2 cache circuitry 1376, level 3 (L3) cache circuitry (not shown), and/or main memory. The L2 cache circuitry 1376 is coupled to one or more other levels of cache and eventually to a main memory.

The core 1390 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1390 includes logic to support a packed data instruction set architecture extension (e.g., AVX1, AVX2), thereby allowing the operations used by many multimedia applications to be performed using packed data.

### Example Execution Unit(s) Circuitry

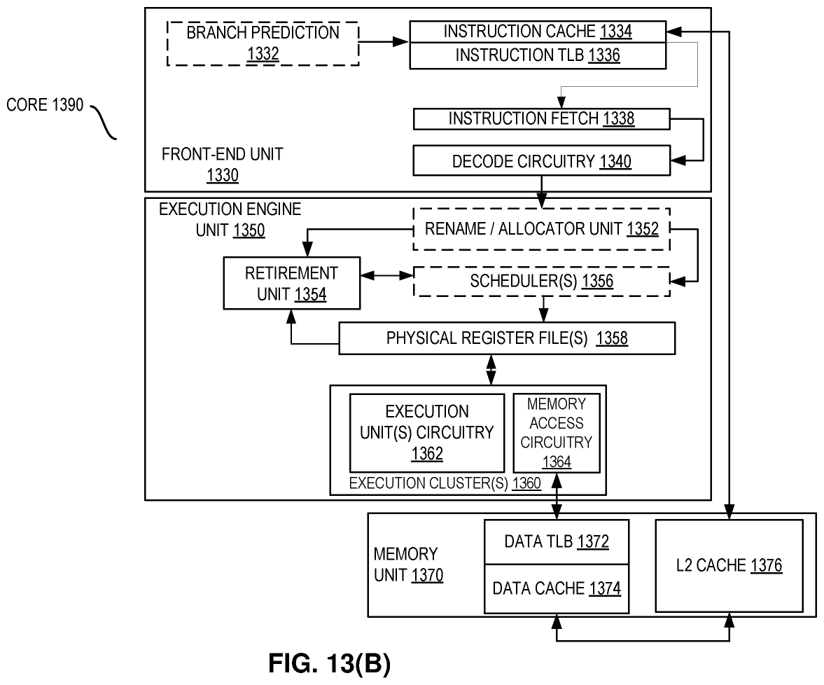

FIG. 14 illustrates examples of execution unit(s) circuitry, such as execution unit(s) circuitry 1362 of FIG. 13(B). As illustrated, execution unit(s) circuitry 1362 may include one or more ALU circuits 1401, optional vector/single instruction multiple data (SIMD) circuits 1403, load/store circuits 1405, branch/jump circuits 1407, and/or Floating-point unit (FPU) circuits 1409. ALU circuits 1401 perform integer arithmetic and/or Boolean operations. Vector/SIMD circuits 1403 perform vector/SIMD operations on packed data (such as SIMD/vector registers). Load/store circuits 1405 execute load and store instructions to load data from memory into registers or store from registers to memory. Load/store circuits 1405 may also generate addresses. Branch/jump circuits 1407 cause a branch or jump to a memory address depending on the instruction. FPU circuits 1409 perform floating-point arithmetic. The width of the execution unit(s) circuitry 1362 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

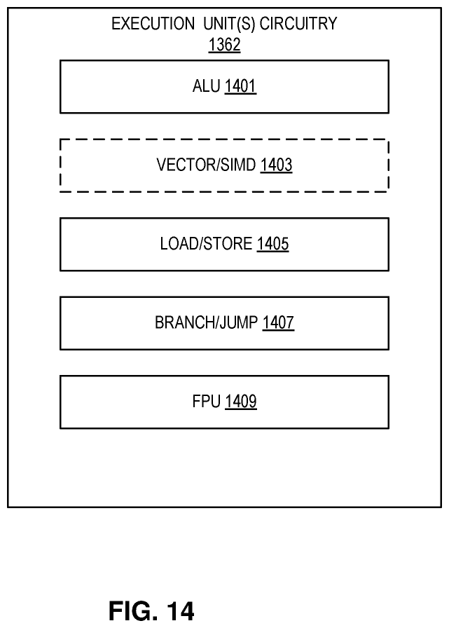

FIG. 15 is a block diagram of a register architecture 1500 according to some examples. As illustrated, the register architecture 1500 includes vector/SIMD registers 1510 that vary from 128-bit to 1,024 bits width. In some examples, the vector/SIMD registers 1510 are physically 512-bits and, depending upon the mapping, only some of the lower bits are used. For example, in some examples, the vector/SIMD registers 1510 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1500 includes writemask/predicate registers 1515. For example, in some examples, there are 8 writemask/predicate registers (sometimes called k0 through k7) that are each 16-bit, 32-bit, 64-bit, or 128-bit in size. Writemask/predicate registers 1515 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1515 corresponds to a data element position of the destination. In other examples, the writemask/predicate registers 1515 are scalable and consists of a set number of enable bits for a given vector element (e.g., 8 enable bits per 64-bit vector element).

The register architecture 1500 includes a plurality of general-purpose registers 1525. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1500 includes scalar floating-point (FP) register file 1545 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1540 (e.g., EFLAGS, RFLAGS, etc.) store status and control information for arithmetic, compare, and system operations. For example, the one or more flag registers 1540 may store condition code information such as carry, parity, auxiliary carry, zero, sign, and overflow. In some examples, the one or more flag registers 1540 are called program status and control registers.

Segment registers 1520 contain segment points for use in accessing memory. In some examples, these registers are referenced by the names CS, DS, SS, ES, FS, and GS.

Model specific registers or machine specific registers (MSRs) 1535 control and report on processor performance. Most MSRs 1535 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 1560 consist of control, status, and error reporting MSRs that are used to detect and report on hardware errors. Control register(s) 1555 (e.g., CR0-CR4) determine the operating mode of a processor (e.g., processor 1170, 1180, 1138, 1115, and/or 1200) and the characteristics of a currently executing task. In some examples, MSRs 1535 are a subset of control registers 1555.

One or more instruction pointer register(s) 1530 store an instruction pointer value. Debug registers 1550 control and allow for the monitoring of a processor or core's debugging operations.

Memory (mem) management registers 1565 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1500 may, for example, be used in register file/memory 1008, or physical register file(s) circuitry 13 58.

Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats

Examples of the instruction(s) described herein may be embodied in different formats. Additionally, example systems, architectures, and pipelines are detailed below.

Examples of the instruction(s) may be executed on such systems, architectures, and pipelines, but are not limited to those detailed.

FIG. 16 illustrates examples of an instruction format. As illustrated, an instruction may include multiple components including, but not limited to, one or more fields for: one or more prefixes 1601, an opcode 1603, addressing information 1605 (e.g., register identifiers, memory addressing information, etc.), a displacement value 1607, and/or an immediate value 1609. Note that some instructions utilize some or all the fields of the format whereas others may only use the field for the opcode 1603. In some examples, the order illustrated is the order in which these fields are to be encoded, however, it should be appreciated that in other examples these fields may be encoded in a different order, combined, etc.

The prefix(es) field(s) 1601, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1603 is used to at least partially define the operation to be performed upon a decoding of the instruction. In some examples, a primary opcode encoded in the opcode field 1603 is one, two, or three bytes in length. In other examples, a primary opcode can be a different length. An additional 3-bit opcode field is sometimes encoded in another field.

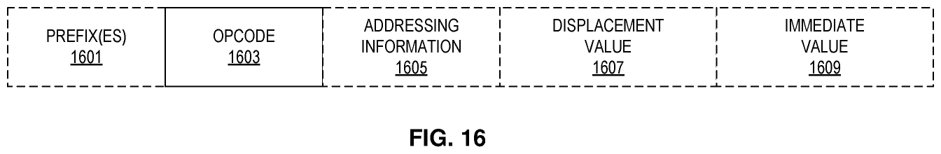

The addressing information field 1605 is used to address one or more operands of the instruction, such as a location in memory or one or more registers. FIG. 17 illustrates examples of the addressing information field 1605. In this illustration, an optional MOD R/M byte 1702 and an optional Scale, Index, Base (SIB) byte 1704 are shown. The MOD R/M byte 1702 and the SIB byte 1704 are used to encode up to two operands of an instruction, each of which is a direct register or effective memory address. Note that both of these fields are optional in that not all instructions include one or more of these fields. The MOD R/M byte 1702 includes a MOD field 1742, a register (reg) field 1744, and R/M field 1746.

The content of the MOD field 1742 distinguishes between memory access and non-memory access modes. In some examples, when the MOD field 1742 has a binary value of 11 (11b), a register-direct addressing mode is utilized, and otherwise a register-indirect addressing mode is used.

The register field 1744 may encode either the destination register operand or a source register operand or may encode an opcode extension and not be used to encode any instruction operand. The content of register field 1744, directly or through address generation, specifies the locations of a source or destination operand (either in a register or in memory). In some examples, the register field 1744 is supplemented with an additional bit from a prefix (e.g., prefix 1601) to allow for greater addressing.

The R/M field 1746 may be used to encode an instruction operand that references a memory address or may be used to encode either the destination register operand or a source register operand. Note the R/M field 1746 may be combined with the MOD field 1742 to dictate an addressing mode in some examples.

The SIB byte 1704 includes a scale field 1752, an index field 1754, and a base field 1756 to be used in the generation of an address. The scale field 1752 indicates a scaling factor. The index field 1754 specifies an index register to use. In some examples, the index field 1754 is supplemented with an additional bit from a prefix (e.g., prefix 1601) to allow for greater addressing. The base field 1756 specifies a base register to use. In some examples, the base field 1756 is supplemented with an additional bit from a prefix (e.g., prefix 1601) to allow for greater addressing. In practice, the content of the scale field 1752 allows for the scaling of the content of the index field 1754 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1607 provides this value. Additionally, in some examples, a displacement factor usage is encoded in the MOD field of the addressing information field 1605 that indicates a compressed displacement scheme for which a displacement value is calculated and stored in the displacement field 1607.

In some examples, the immediate value field 1609 specifies an immediate value for the instruction. An immediate value may be encoded as a 1-byte value, a 2-byte value, a 4-byte value, etc.

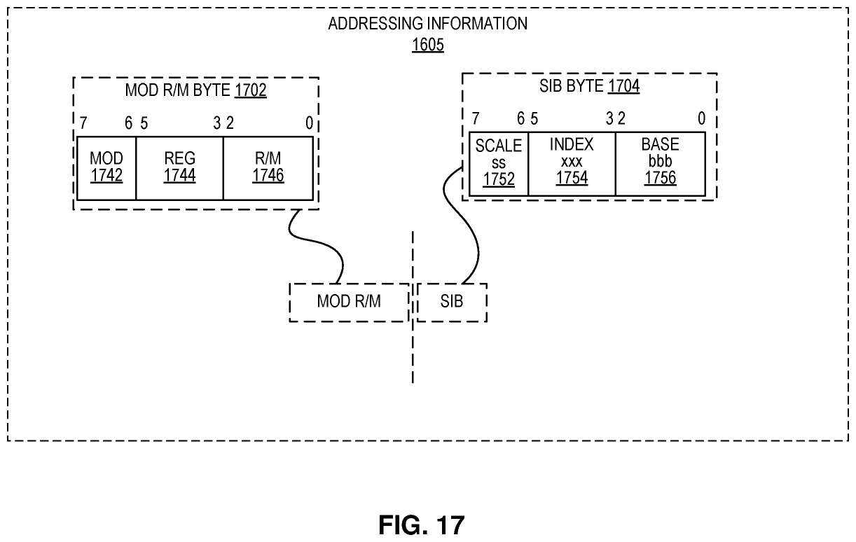

FIG. 18 illustrates examples of a first prefix 1601(A). In some examples, the first prefix 1601(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1601(A) may specify up to three registers using 3-bit fields depending on the format: 1) using the reg field 1744 and the R/M field 1746 of the MOD R/M byte 1702; 2) using the MOD R/M byte 1702 with the SIB byte 1704 including using the reg field 1744 and the base field 1756 and index field 1754; or 3) using the register field of an opcode.

In the first prefix 1601(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1744 and MOD R/M R/M field 1746 alone can each only address 8 registers.

In the first prefix 1601(A), bit position 2 (R) may be an extension of the MOD R/M reg field 1744 and may be used to modify the MOD R/M reg field 1744 when that field encodes a general-purpose register, a 64-bit packed data register (e.g., a SSE register), or a control or debug register. R is ignored when MOD R/M byte 1702 specifies other registers or defines an extended opcode.

Bit position 1 (X) may modify the SIB byte index field 1754.

Bit position 0 (B) may modify the base in the MOD R/M R/M field 1746 or the SIB byte base field 1756; or it may modify the opcode register field used for accessing general purpose registers (e.g., general purpose registers 1525).

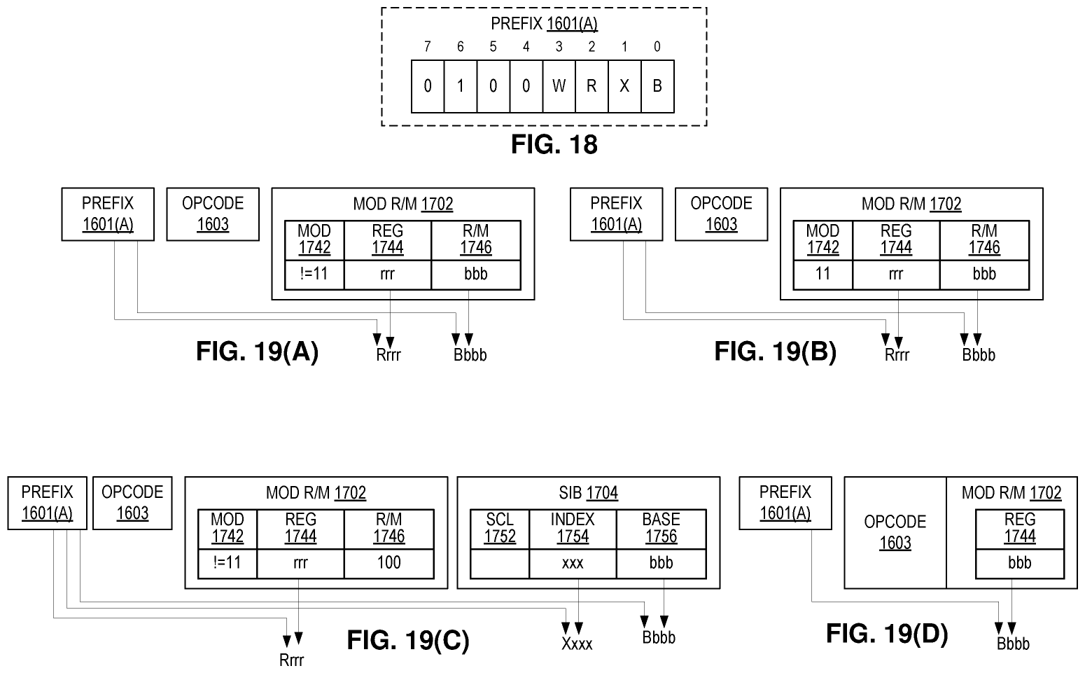

FIGS. 19(A)-(D) illustrate examples of how the R, X, and B fields of the first prefix 1601(A) are used. FIG. 19(A) illustrates R and B from the first prefix 1601(A) being used to extend the reg field 1744 and R/M field 1746 of the MOD R/M byte 1702 when the SIB byte 17 04 is not used for memory addressing. FIG. 19(B) illustrates R and B from the first prefix 1601(A) being used to extend the reg field 1744 and R/M field 1746 of the MOD R/M byte 1702 when the SIB byte 17 04 is not used (register-register addressing). FIG. 19(C) illustrates R, X, and B from the first prefix 1601(A) being used to extend the reg field 1744 of the MOD R/M byte 1702 and the index field 1754 and base field 1756 when the SIB byte 17 04 being used for memory addressing. FIG. 19(D) illustrates B from the first prefix 1601(A) being used to extend the regfield 1744 of the MOD R/M byte 1702 when a register is encoded in the opcode 1603.

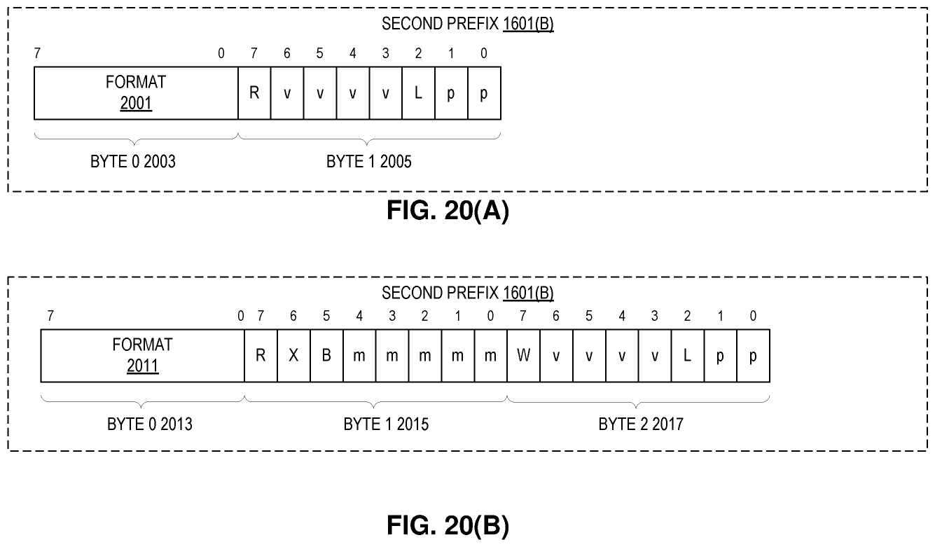

FIGS. 20(A)-(B) illustrate examples of a second prefix 1601(B). In some examples, the second prefix 1601(B) is an example of a VEX prefix. The second prefix 1601(B) encoding allows instructions to have more than two operands, and allows SIMD vector registers (e.g., vector/SIMD registers 1510) to be longer than 64-bits (e.g., 128-bit and 256-bit). The use of the second prefix 1601(B) provides for three-operand (or more) syntax. For example, previous two-operand instructions performed operations such as A=A+B, which overwrites a source operand. The use of the second prefix 1601(B) enables operands to perform nondestructive operations such as A=B+C.

In some examples, the second prefix 1601(B) comes in two forms—a two-byte form and a three-byte form. The two-byte second prefix 1601(B) is used mainly for 128-bit, scalar, and some 256-bit instructions; while the three-byte second prefix 1601(B) provides a compact replacement of the first prefix 1601(A) and 3-byte opcode instructions.

FIG. 20(A) illustrates examples of a two-byte form of the second prefix 1601(B). In one example, a format field 2001 (byte 0 2003) contains the value C5H. In one example, byte 1 2005 includes an “R” value in bit[7]. This value is the complement of the “R” value of the first prefix 1601(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1746 to encode the instruction operand that references a memory address or encode either the destination register operand or a source register operand.

Instructions that use this prefix may use the MOD R/M reg field 1744 to encode either the destination register operand or a source register operand, or to be treated as an opcode extension and not used to encode any instruction operand.

For instruction syntax that support four operands, vvvv, the MOD R/M R/M field 1746 and the MOD R/M reg field 1744 encode three of the four operands. Bits[7:4] of the immediate value field 1609 are then used to encode the third source register operand.

FIG. 20(B) illustrates examples of a three-byte form of the second prefix 1601(B). In one example, a format field 2011 (byte 0 2013) contains the value C4H. Byte 1 2015 includes in bits[7:5] “R,” “X,” and “B” which are the complements of the same values of the first prefix 1601(A). Bits[4:0] of byte 1 2015 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 2017 is used similar to W of the first prefix 1601(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1746 to encode the instruction operand that references a memory address or encode either the destination register operand or a source register operand.

Instructions that use this prefix may use the MOD R/M reg field 1744 to encode either the destination register operand or a source register operand, or to be treated as an opcode extension and not used to encode any instruction operand.

For instruction syntax that support four operands, ww, the MOD R/M R/M field 1746, and the MOD R/M reg field 1744 encode three of the four operands. Bits[7:4] of the immediate value field 1609 are then used to encode the third source register operand.

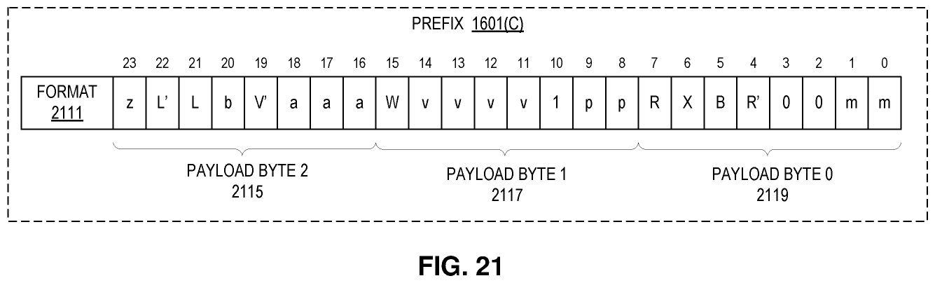

FIG. 21 illustrates examples of a third prefix 1601(C). In some examples, the third prefix 1601(C) is an example of an EVEX prefix. The third prefix 1601(C) is a four-byte prefix.

The third prefix 1601(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 15) or predication utilize this prefix. Opmask register allow for conditional processing or selection control. Opmask instructions, whose source/destination operands are opmask registers and treat the content of an opmask register as a single value, are encoded using the second prefix 1601(B).

The third prefix 1601(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1601(C) is a format field 2111 that has a value, in one example, of 62H. Subsequent bytes are referred to as payload bytes 2115-2119 and collectively form a 24-bit value of P[23:0] providing specific capability in the form of one or more fields (detailed herein).

In some examples, P[1:0] of payload byte 2119 are identical to the low two mm bits. P[3:2] are reserved in some examples. Bit P[4] (R′) allows access to the high 16 vector register set when combined with P[7] and the MOD R/M reg field 1744. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1744 and MOD R/M R/M field 1746. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as ww, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 1601(A) and second prefix 1611(B) and may serve as an opcode extension bit or operand size promotion.

P[18:16] specify the index of a register in the opmask (writemask) registers (e.g., writemask/predicate registers 1515). In one example, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmaskfield's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1601(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination or Source |
| | | | reg | | |
| VVVV | V′ | vvvv | | GPR, Vector | 2nd Source or |
| | | | | | Destination |
| RM | X | B | MOD R/M | GPR, Vector | 1st Source or Destination |
| | | | R/M | | |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

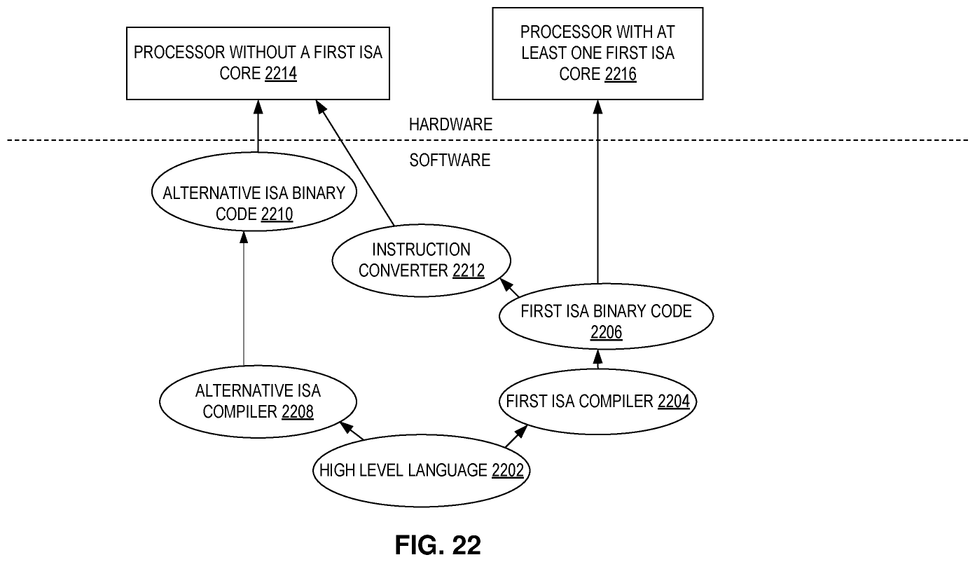

FIG. 22 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 22 shows a program in a high-level language 2202 may be compiled using a first ISA compiler 2204 to generate first ISA binary code 2206 that may be natively executed by a processor with at least one first ISA core 2216. The processor with at least one first ISA core 2216 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 2204 represents a compiler that is operable to generate first ISA binary code 2206 (e.g., object code) that can, with or without additional linkage processing, be executed on the processor with at least one first ISA core 2216. Similarly, FIG. 22 shows the program in the high-level language 2202 may be compiled using an alternative ISA compiler 2208 to generate alternative ISA binary code 2210 that may be natively executed by a processor without a first ISA core 2214. The instruction converter 2212 is used to convert the first ISA binary code 2206 into code that may be natively executed by the processor without a first ISA core 2214. This converted code is not necessarily to be the same as the alternative ISA binary code 2210; however, the converted code will accomplish the general operation and be made up of instructions from the alternative ISA. Thus, the instruction converter 2212 represents software, firmware, hardware, or a combination thereof that, through emulation, simulation or any other process, allows a processor or other electronic device that does not have a first ISA processor or core to execute the first ISA binary code 2206.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Examples include, but are not limited to:

1. An apparatus comprising:
decoder circuitry to decode an instance of a single instruction, the single instruction to include a field for an opcode; and
execution circuitry to execute the decoded instruction according to the opcode to return the processor identification and feature information including an enumeration of heterogenous performance monitoring unit capabilities.
   2. The apparatus of example 1, wherein the performance monitoring unit's capabilities are enumerated using a leaf at EAX=23H.
   3. The apparatus of any of examples 1-2, wherein the heterogenous performance monitoring unit capabilities include an indication of valid sub-leafs.
   4. The apparatus of any of examples 1-3, wherein the heterogenous performance monitoring unit capabilities include an indication of supported general-purpose counters.
   5. The apparatus of any of examples 1-4, wherein the heterogenous performance monitoring unit capabilities include an indication of supported fixed-function counters.
   6. The apparatus of any of examples 1-5, wherein the heterogenous performance monitoring unit capabilities include an indication of supported performance monitor events.
   7. The apparatus of any of examples 1-6, wherein the opcode is 0F A2.
   8. A method comprising:
decoding an instance of a single instruction, the single instruction to include a field for an opcode; and
executing the decoded instruction according to the opcode to return the processor identification and feature information including an enumeration of heterogenous performance monitoring unit capabilities.
   9. The method of example 8, wherein the heterogenous performance monitoring unit capabilities are enumerated using a leaf at EAX=23H.
   10. The method of any of examples 8-9, wherein the heterogenous performance monitoring unit capabilities enumerated include an indication of valid sub-leafs.
   11. The method of any of examples 8-10, wherein the heterogenous performance monitoring unit capabilities enumerated include an indication of supported general-purpose counters.
   12. The method of any of examples 8-11, wherein the heterogenous performance monitoring unit capabilities enumerated include an indication of supported fixed-function counters.
   13. The method of any of examples 8-12, wherein the heterogenous performance monitoring unit capabilities enumerated include an indication of supported performance monitor events.
   14. The method of any of examples 8-13, wherein the opcode is 0F A2.
   15. A system comprising method comprising:
memory to store an instance of a single instruction;
a processor core including:
   decoder circuitry to decode the instance of the single instruction, the single instruction to include a field for an opcode; and
   execution circuitry to execute the decoded instruction according to the opcode to return the processor identification and feature information including an enumeration of heterogenous performance monitoring unit capabilities.
      16. The system of example 15, wherein the heterogenous performance monitoring unit capabilities are enumerated using a leaf at EAX=23H.
      17. The system of any of examples 15-16, wherein the heterogenous performance monitoring unit capabilities enumerated include an indication of valid sub-leafs.
      18. The system of any of examples 15-17, wherein the heterogenous performance monitoring unit capabilities enumerated include an indication of supported general-purpose counters.
      19. The system of any of examples 15-18, wherein the heterogenous performance monitoring unit capabilities enumerated include an indication of supported fixed-function counters.
      20. The system of any of examples 15-19, wherein the heterogenous performance monitoring unit capabilities enumerated include an indication of supported performance monitor events.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
decoder circuitry to decode an instance of a single instruction, the single instruction to include a field for an opcode; and
execution circuitry to execute the decoded instruction according to the opcode to return the processor identification and feature information including an enumeration of heterogenous performance monitoring unit capabilities.

2. The apparatus of claim 1, wherein the performance monitoring unit's capabilities are enumerated using a leaf at EAX=23H.

3. The apparatus of claim 1, wherein the heterogenous performance monitoring unit capabilities include an indication of valid sub-leafs.

4. The apparatus of claim 1, wherein the heterogenous performance monitoring unit capabilities include an indication of supported general-purpose counters.

5. The apparatus of claim 1, wherein the heterogenous performance monitoring unit capabilities include an indication of supported fixed-function counters.

6. The apparatus of claim 1, wherein the heterogenous performance monitoring unit capabilities include an indication of supported performance monitor events.

7. The apparatus of claim 1, wherein the opcode is 0F A2.

8. A method comprising:
decoding an instance of a single instruction, the single instruction to include a field for an opcode; and
executing the decoded instruction according to the opcode to return the processor identification and feature information including an enumeration of heterogenous performance monitoring unit capabilities.

9. The method of claim 8, wherein the heterogenous performance monitoring unit capabilities are enumerated using a leaf at EAX=23H.

10. The method of claim 8, wherein the heterogenous performance monitoring unit capabilities enumerated include an indication of valid sub-leafs.

11. The method of claim 8, wherein the heterogenous performance monitoring unit capabilities enumerated include an indication of supported general-purpose counters.

12. The method of claim 8, wherein the heterogenous performance monitoring unit capabilities enumerated include an indication of supported fixed-function counters.

13. The method of claim 8, wherein the heterogenous performance monitoring unit capabilities enumerated include an indication of supported performance monitor events.

14. The method of claim 8, wherein the opcode is 0F A2.

15. A system comprising method comprising:
memory to store an instance of a single instruction;
a processor core including:
decoder circuitry to decode the instance of the single instruction, the single instruction to include a field for an opcode; and
execution circuitry to execute the decoded instruction according to the opcode to return the processor identification and feature information including an enumeration of heterogenous performance monitoring unit capabilities.

16. The system of claim 15, wherein the heterogenous performance monitoring unit capabilities are enumerated using a leaf at EAX=23H.

17. The system of claim 15, wherein the heterogenous performance monitoring unit capabilities enumerated include an indication of valid sub-leafs.

18. The system of claim 15, wherein the heterogenous performance monitoring unit capabilities enumerated include an indication of supported general-purpose counters.

19. The system of claim 15, wherein the heterogenous performance monitoring unit capabilities enumerated include an indication of supported fixed-function counters.

20. The system of claim 15, wherein the heterogenous performance monitoring unit capabilities enumerated include an indication of supported performance monitor events.
